(19) United States
(12) Patent Application Publication
(10) Pub. No.: US 2008/0208925 A1
(43) Pub. Date: Aug. 28, 2008

(54) Communication Method and System

(75) Inventor: Kam Hong Shum, Hong Kong (HK)

Correspondence Address: WILLIAM J. SAPONE;COLEMAN SUDOL SAPONE P.C., 714 COLORADO AVENUE, BRIDGE PORT, CT, 06605, US

(73) Assignee: SENERATION COMPANY LIMITED, North Point (HK)

(21) Appl. No.: 11/994,961

(22) PCT Filed: Aug. 19, 2005
(86) PCT No.: PCT/CN05/01303

§ 371 Date: Jan. 7, 2008

(51) Int. Cl. G06F 17/40; H04K 1/00; G06F 17/30

(52) U.S. Cl. 707/202; 380/258; 707/E17.008; 707/E17.018; 707/E17.104

(57) ABSTRACT

A communication method is disclosed as including the steps of (a) associating sensor with an object; (b) associating a mobile phone or personal digital assistant with a secure token capable of communication contactlessly with the sensor; (c) setting a number of rules of possible allowable ways of interaction between the object and the mobile pone; (d) the sensor obtaining information relating to the object; (e) the secure token initiating and establishing information contactless communication with the sensor and receiving from the sensor the information obtained by the sensor; and (f) the secure token issuing an output on the basis of the rules of possible or allowable ways of interaction and the information received from the sensor.

### FIELD OF THE INVENTION

This invention relates to a communication method and system, in particular such a method and system for wireless and contactless applications on mobile devices and distributed information technology (IT) systems, in particular for tracking and monitoring interactions between objects.

### BACKGROUND OF THE INVENTION

With the advent of contactless and wireless technology, the drive for ubiquitous computing is growing rapidly. The capability of being connected at any time and any place becomes critical in mobile applications.

To facilitate this capability, sensors such as radio frequency (RF) sensors and infrared (IR) sensors can be embedded or attached to a physical object. The sensors can store meaningful data such as identification of the object or measure and detect the status of the physical object, such as temperature readings of the object. The sensors can also communicate with a wireless device that is owned by a human user. The wireless device can then be connected to other distributed IT systems via a wireless communication device or system.

The need of this kind of interactions and co-ordinations among sensors, wireless device and distributed IT systems is compelling especially for mobile commercial applications. This is critical to allow customers to connect to services provided by manufacturers and brand owners directly.

For example, a car manufacturer can provide services to its customers for a kind of on-demand monitoring service. A user can obtain the operation status and conditions of his/her car by connecting his/her mobile phone with sensors that have been installed and connected to the monitoring system in the car. The mobile phone with RF capability can either analyze the measurements by its own capability or connect to the IT systems of the car manufacturer directly for analysis.

Innovative use of embedded sensors can enhance human productivity tremendously. Sensors that can sense, reason, communicate and act will eventually outnumber humans. Sensors will be seamlessly deployed everywhere and sensors will form a network/web that can communicate seamlessly with any devices.

Nowadays most of these sensors can only communicate with special readers that will only be deployed for specific proprietary applications. However, the adoption of sensor-based applications will increase dramatically because of recent development on contactless technology.

One good example of the latest development of contactless technology is Near Field Communication (NFC). NFC is a kind of short-range communication between two devices with NFC capability. It allows the user to exchange information simply by bringing two devices sufficiently close together. With NFC, personal wireless devices provide the best platform for bridging the communication gap between humans and sensors, as NFC enables communication between sensors and wireless devices through radio frequency. Another possible form of contactless communication is through Infrared frequency.

It is now technically possible to establish communications among sensors, wireless devices and distributed IT systems. However, these devices and systems need to be interacting in a coordinated manner. For example, a human user would definitely like the sensors, devices and systems to sense, reason, communicate and act according to his/her desire.

Many interesting mobile applications will be possible if a human can interact with his/her surrounding sensors, mobile devices of his/her peers and other distributed IT systems in a coordinated manner. These interactions need to act and respond based on pre-set rules in a trusted environment.

The objectives of these pre-set rules are to:
facilitate authentication among devices and systems;
check and control the actions and responses of devices and systems during interactions; and
track and analyze interactions among devices and systems

There is no existing framework to provide a trusted environment to manage these pre-set rules. A framework is required to track and control how sensors, wireless devices and networked systems interact with one another. Humans will then be able to interact with physical objects (such as toys, electronic appliances, personal computers, cars, consumer product, etc) with embedded sensors via their wireless devices under this framework.

Another limitation of the existing technology is the human interface with the sensors and other related systems. When a human user interacts with sensors (e.g. RF sensors), there is no way for the user to visualize actions and instructions which run internally in the sensors (called SN Sensors in the present document), the personal hardware token which represents the user (called SN Agent in the present document), and related distributed IT systems (generally called SN Servers in the present document).

For simple and single-mission applications such as electronic ticketing via contactless payment, a human user may be able to “trust” the sensors and the personal hardware token to carry out the necessary actions and instructions that run in the sensors and the token. This is because the user can easily verify the result of the actions and instructions. In the example of electronic ticketing, the user can verify the actions and instructions by checking the balance of his bank account from which money is drawn for such transactions.

However, the interface and mechanisms for users to interact with sensors and related distributed IT systems will become seriously inadequate for sophisticated applications such as applications that aim at improving lifestyle and productivity. For example, the user will be worried as to whether the interaction will trigger unauthorized and malicious actions on sensitive and private data stored in the personal hardware token. With existing technology, it is not possible to guarantee that all parties involved in the interactions will behave as “promised”.

It is thus an objective of the present invention to provide a platform, a method and a system for tracking and monitoring interactions between objects for realizing the aforesaid object, or at least to provide a useful alternative to the public.

### SUMMARY OF THE INVENTION

According to a first aspect of the present invention, there is provided a communication method, including the steps of (a) associating at least one sensor with a first object; (b) associating a second object with at least one secure token adapted to communicate contactlessly with said sensor; (c) setting at least a first rule of possible or allowable way of interaction between said first and second object; (d) said sensor obtaining information relating to said first object; (e) said secure token initiating and establishing contactless communication with said sensor and receiving from said sensor said information obtained by said sensor; and (f) said secure token issuing an output on the basis of said at least first rule of possible or allowable way of interaction and said information received from said sensor.

According to a second aspect of the present invention, there is provided a communication system comprising at least one sensor associated with, and adapted to obtain information relating to, a first object, and at least one secure token associated with a second object; wherein said secure token is adapted to initiate and establish contactless communication with said sensor and to receive from said sensor said information obtained by said sensor; and wherein said secure token is adapted to issue an output on the basis of at least a first pre-set rule of possible or allowable way of interaction between said first and second objects and said information received from said sensor.

### BRIEF DESCRIPTION OF THE DRAWINGS

Embodiments of the present invention will now be described, by way of examples only, with reference to the accompanying drawings, in which:

FIG. 1 is a schematic view of a Sensing Network with Sensing Network Objects according to the present invention;

FIG. 2 shows the structure of a Behavioral State Table according to the present invention;

FIG. 3 shows a Private Sensing Network according to the present invention;

FIG. 4 shows how Behavioral States are converted into Historical State Profiles;

FIG. 5 shows a possible hierarchy of associations among a user with various SN Objects;

FIG. 6 shows how Behavioral Contracts (b-Contracts) may relate to SN Objects in a Sensing Network;

FIG. 7 shows the data elements of a Behavioral Contract;

FIG. 8 shows examples of State-Action Links, State Checkpoints and Actions IDs;

FIG. 9 shows an exemplary Sensor-Agent-Sever Interaction according to the present invention;

FIG. 10 shows the steps of b-footprinting during a Sensor-Agent-Sever Interaction;

FIG. 11 shows an exemplary Agent-Agent-Sever Interaction according to the present invention;

FIGS. 12A and 12B combine to show steps of b-footprinting during an Agent-Agent-Sever Interaction;

FIG. 13 shows an exemplary Sensor-Agent Interaction;

FIG. 14 shows the steps of b-footprinting during a Sensor-Agent Interaction;

FIG. 15 shows an exemplary Agent-Agent Interaction;

FIG. 16 shows the steps of b-footprinting during an Agent-Agent Interaction;

FIG. 17 shows the steps of generation of b-footprint and authentication and integrity token;

FIG. 18 shows the steps of b-Contract compliance checking;

FIG. 19 shows the steps of execution of an action based on a Sensor-Side or Server-Side Action Execution Request Message;

FIG. 20 shows a number of possible applications of the method and system according to the present invention;

FIG. 21 shows the use of a system and method according to the present invention in a customer self-served relationship management with brand-owners;

FIG. 22 shows the use of a system and method according to the present invention in a direct customer support and servicing system;

FIG. 23 shows the use of a system and method according to the present invention in a virtual personal tutoring system;

FIG. 24 shows the use of a system and method according to the present invention in parallel interaction with Internet and mobile channels;

FIG. 25 shows the use of a system and method according to the present invention in a peer-sensing scenario;

FIG. 26 shows the use of a system and method according to the present invention in a remote sensing scenario, with remote intelligent sensors with the capability of handling multi-media data streams;

FIG. 27 shows a software infrastructure for an SN Sensor for mobile sensing services according to the present invention;

FIG. 28 shows a software infrastructure for an SN Agent for mobile sensing services according to the present invention; and

FIG. 29 shows a software infrastructure for an SN Server for mobile sensing services.

### DESCRIPTION OF EMBODIMENTS OF THE INVENTION

A glossary of some of the terms used in this specification and some basic explanations are first given below.

Behavioral States: Behavioral States represent the snapshots of status of an SN Object during interaction. Behavioral States store not only the information about the measurements of the SN Objects from the environment but also the history or records of the interactions among SN Objects. It also stores the responses of a user during interactions.

Behavioral Contract (b-Contract): This is an electronic form of a contract that defines how SN Objects should interact. It defines all the information required to bind the interactions among SN objects. SN objects are required to respond to other SN objects based on the contents in the contract and the Behavioral States that are related to the contract.

Behavioral Footprint (b-footprint): Behavioral footprint is a compacted data object that mainly consists of a selection of current and historical profiles of Behavioral States. A b-footprint will be generated by an SN Agent if the SN Agent needs an SN Server for performing b-footprinting. The information of the Behavioral States can be restored by decompressing the b-footprint by the SN Server.

Behavioral Footprinting (b-footprinting): Behavioral footprinting is a method to check whether the SN Objects being associated with a b-Contract interact based on the details of the b-Contract.

Environment: The environment is the physical object where the SN Sensor is embedded. For example, the environment is a monitoring system of a car and the SN Sensor is a device that could detect and measure the operation conditions of different parts in the car through the monitoring system.

Personal Hardware Token: A Personal Hardware Token is a secure token that is embedded in the personal mobile device. It has the following characteristics:
Capable of communicating with SN Sensors via contactless technology
Possess temper-proof or temper-resist memory for data storage.
Possess different ranges of processing capabilities

Examples of Personal Hardware Token include:
SIM (Subscriber Identification Module) on a mobile device with NFC (Near Field Communication) capability
USIM (Universal Subscriber Identification Module) on a mobile device with NFC capability
Flash card on a mobile device with a radio frequency antenna
Multimedia card on a mobile device with a radio frequency antenna

Personal Hardware Token can be the proxy for the human user to perform electronic transactions, especially for sensitive and important applications. It provides a trusted environment to store private data and sensitive programs and allows secure user authentication during the interaction.

Sensing Network (SN): A Sensing Network is defined as the network of software objects that are capable of communicating with one another using either wireless and/or wired (connection-based) protocols.

Sensing Network Objects (SN Objects): The software objects in a Sensing Network are called Sensing Network Objects. There are three types of SN Objects, namely SN Sensors, SN Agents and SN Servers.

Sensing Application: Sensing applications are the applications that involve and realize the interactions of SN Objects. Each sensing application is the platform for delivering a specific service to a user. For example, a sensing application could perform health monitoring for patients or services for customers. A sensing application can associate with more than one SN Object and an SN Object can sign up to multiple sensing applications.

Sensing Application Identifier (SAI): Sensing Application Identifier is a data identifier that is used for uniquely identifying a sensing application. SAI is used during communication between SN Objects for identifying data and actions related to a specific sensing application.

Sensing Network Sensor (SN Sensor): SN Sensors refer to sensing devices with different processing and communication capabilities. For example, they can be RFID or RF sensors with capabilities in processing and handling multimedia data. SN Sensors can store data and/or make measurements of information from the environment. They can also communicate with SN Agents.

Sensing Network Agent (SN Agent): Sensing Network Agents are the software objects that run in a Personal Hardware Token of the personal mobile device. SN Agents interact with other SN objects on-behalf of the human user or an autonomous software entity. An SN Agent can also interact with other SN Agents to form a kind of a peer-to-peer interaction. SN Agent is also responsible for the secure storage of the private data of the user. For example, it can be the proxy for a human user to perform electronic transactions especially for sensitive and important applications such as financial applications.

Sensing Network Server (SN Server): Sensing Network Servers refer to software objects that run on hardware server systems with substantial processing and communication capabilities. SN Servers supports SN Agents for extended capability of processing Examples of SN Servers include legacy enterprise applications and specialized applications for coordinating interactions of SN Objects.

Except for SN Servers, SN Sensors and SN Agents usually run on hardware with limited communication and processing capabilities.

SN Sensors can normally provide data in a primitive format without any special processing and/or formatting.

Due to limitations in communication, sensors can only interact with SN Agents through RF technology such as Near Field Communication (NFC). SN Agents usually communicate with SN Sensors using wireless technology, such as RF and IR technologies.

On the other hand, SN Agents communicate with SN Servers using wireless (GPRS & 3G) and/or wired technology (TCP/IP, HTTP, Web services).

In addition to exchange of information, interactions between SN Sensors and SN Agents may also involve location-based data and time-based data, i.e. where and when the user interacts with a physical device such as a toy with an embedded sensor.

An SN Agent will either analyze the data sent from SN Sensors with its own processing capability or it will rely on its related SN Servers for data analysis.

Interactions among SN Objects will also be restricted by whether they are associated to one another. The association among a group of SN Objects is defined by a special data object called Behavioral Contract. The details of Behavioral contract will be described later in this document.

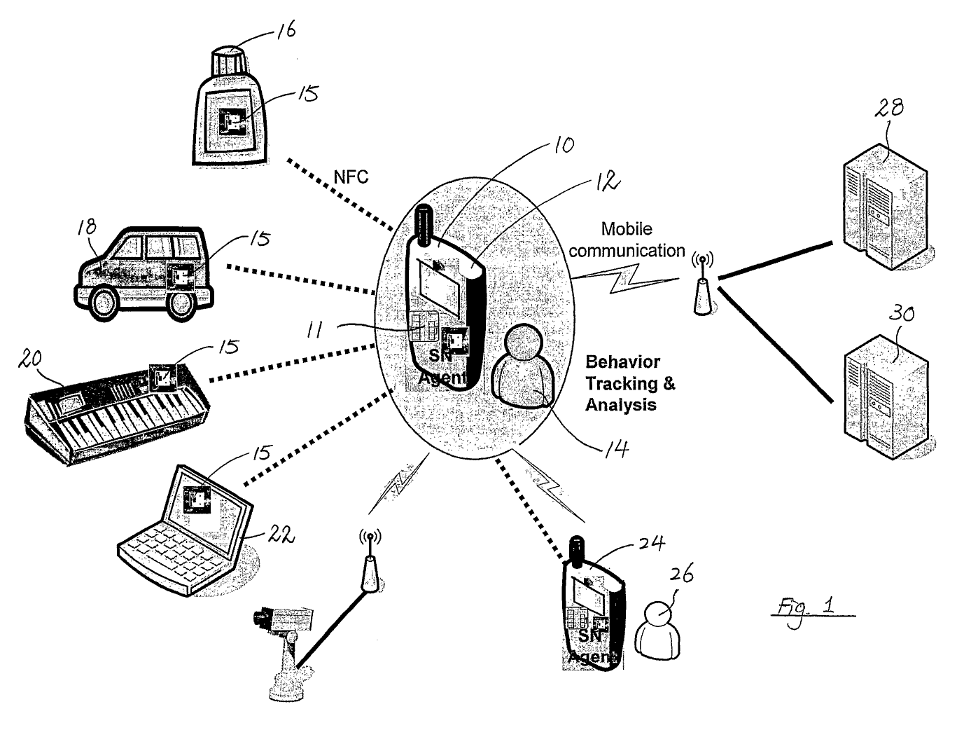

As shown in FIG. 1, a system for tracking and monitoring interactions between objects according to the present invention includes an SN Agent 10, represented by a SIM card 11 in a mobile device (such as a mobile phone 12) of an individual 14. The SIM card 11 is provided with software to enable it to interact with other SN Objects on behalf of the individual 14. Such SN Objects may include RF Sensors or IR Sensors 15 embedded or otherwise associated with an item of goods 16, a car 18, an electronic piano 20, and a personal computer (PC) 22, by Near Field Communication (NFC) technology. The RF Sensors, in addition to contain information relating to the objects to which it is embedded or associated, e.g. identity of manufacturer, identity of product, date of production, batch number, serial number, etc., can also detect or capture data and information relating to the status and/or condition of the object, e.g. the volume of content of product left, the condition of the mileage of a car, etc.

The SN Agent 10 may also communicate and interact with another SN Agent 24 of another individual 26 via a telecommunication network. As can be seen in FIG. 1, the SN Agent 10 is also in a communicable relationship with SN Servers, which may be an enterprise application server 28, and a server provider's application server 30.

As discussed above, the interactions among the SN Objects in a sensing network will involve attributes like time, location, action, responses and other physical measurements from the environment. Examples of the physical measurements include temperature, moving speed, operation status etc.

Behavior of an SN Object is defined as the patterns of interactions of the SN Object in a sensing network. To represent the behavior of an SN Object, the attributes of the interactions are represented as the snapshots of status during the interaction. These snapshots of status are categorized as Behavioral States of an SN Object.

Since an SN Agent could represent a human user during interactions, the Behavioral States of an SN Agent can be used for representing the behaviors of a human user. Behavioral States are stored at the Personal Hardware Token of the user's wireless/mobile device. The current or historical information that describe the behavior of a specific SN Agent are stored in each State.

Based on the Behavioral States recorded for an SN Agent, the behaviors of a human user can then be measured, monitored and analyzed.

Behavioral States store not only the information about the measurements of SN Objects but also the history or records of the interactions among SN Objects. It also stores the responses of a user during interactions. The storage format of each state is designed in a way that the information can be stored efficiently in various digital devices with limited storage capabilities (e.g. USIM/SIM card, secure flash memory or Multimedia Card etc)

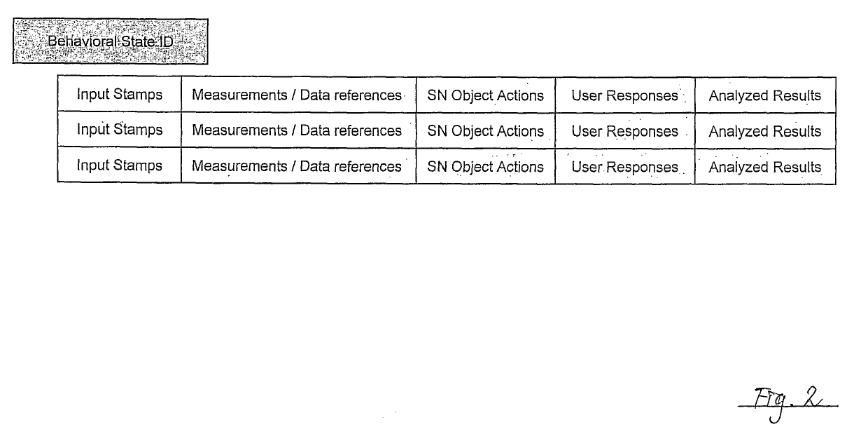

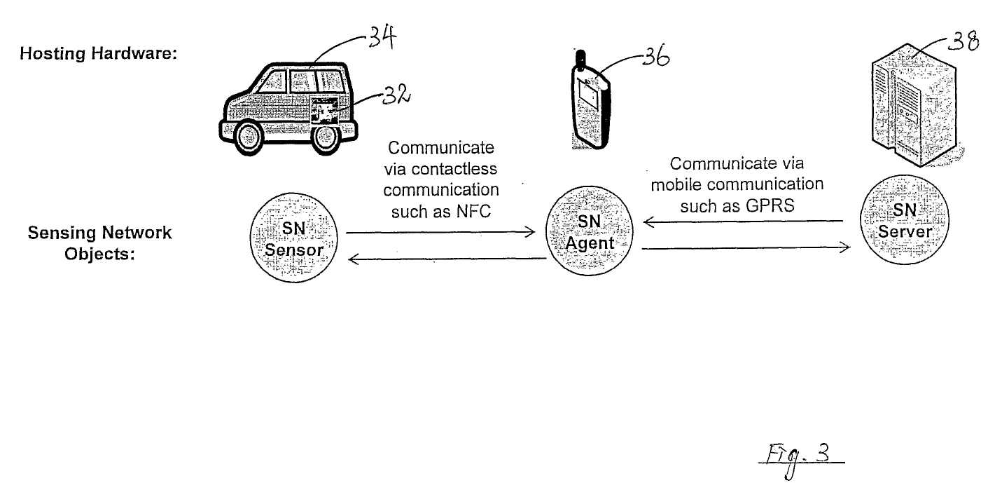

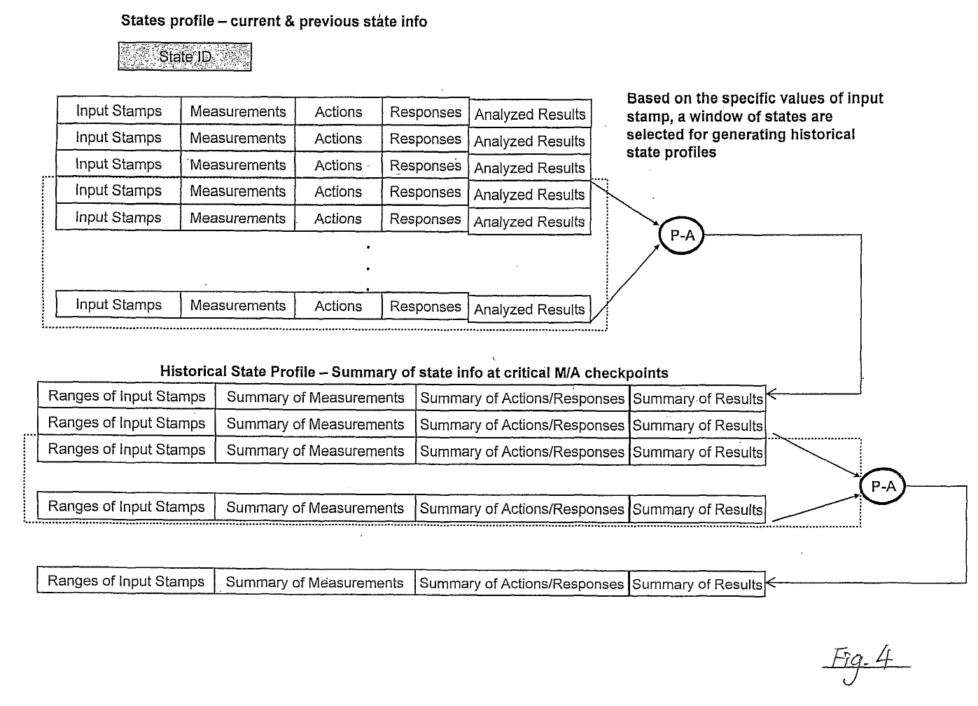

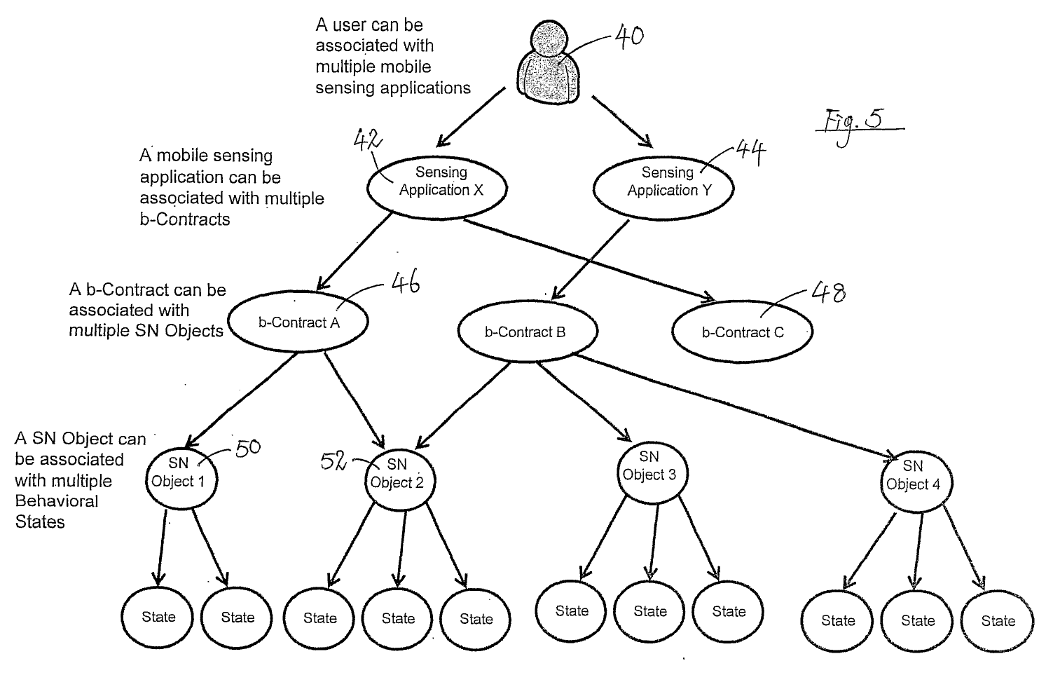

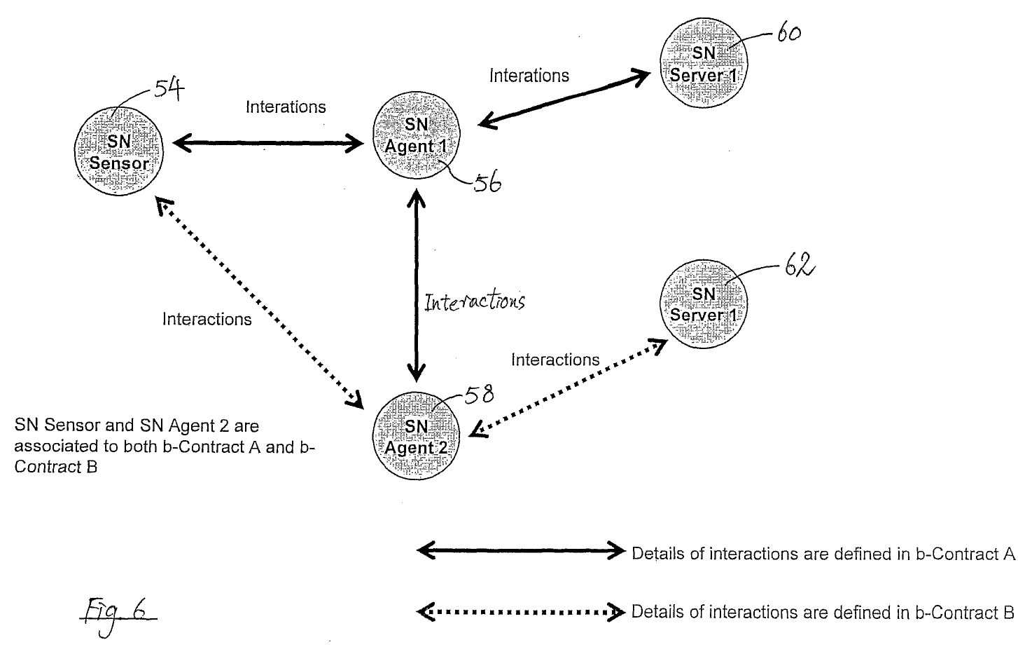

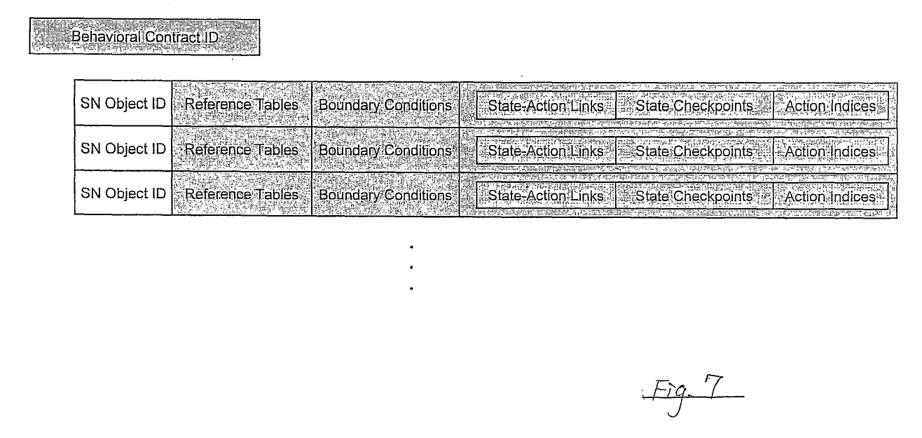

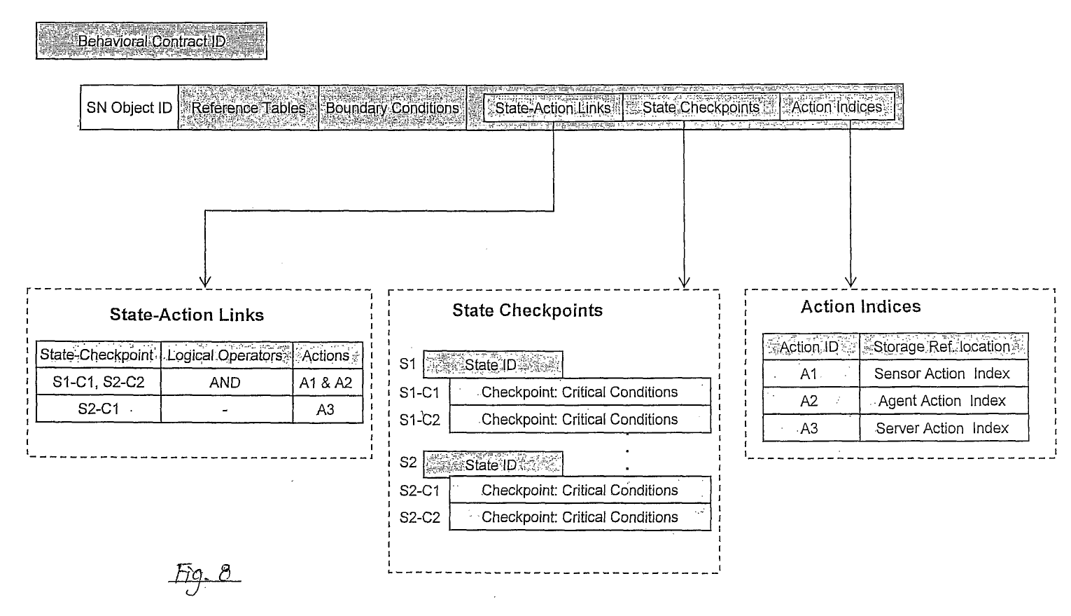

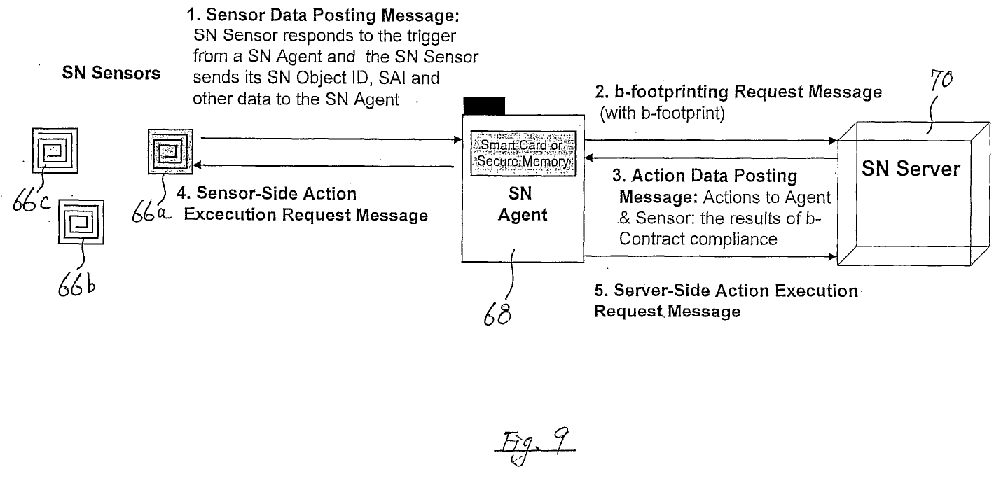

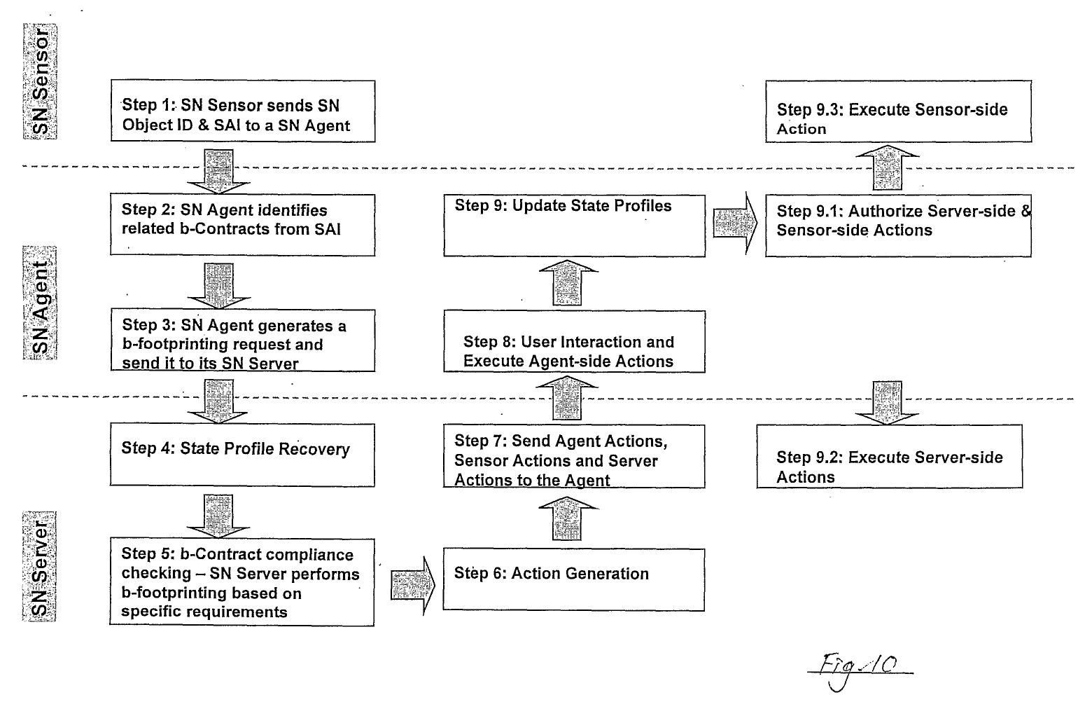

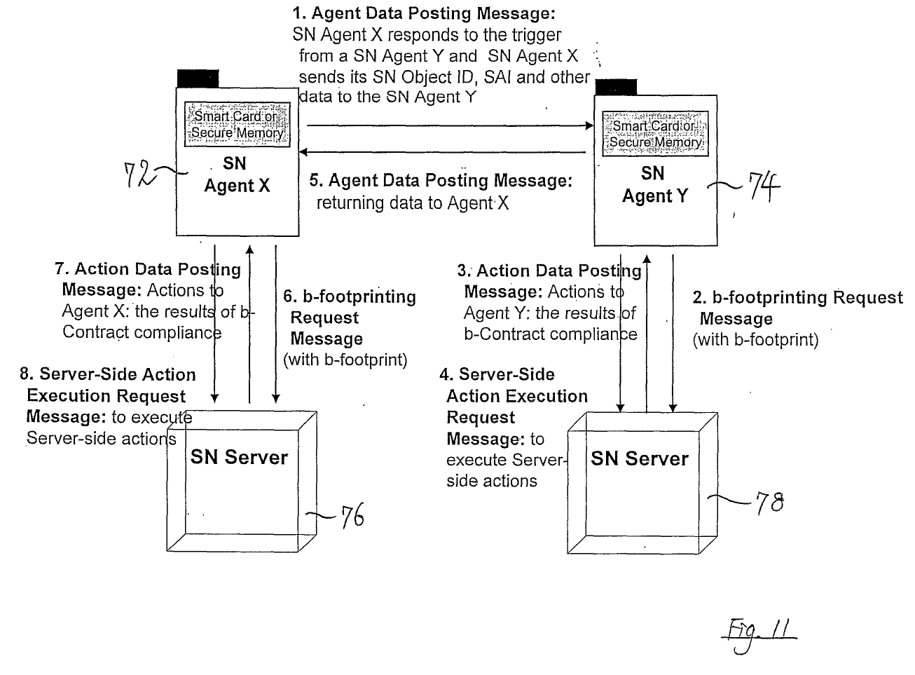

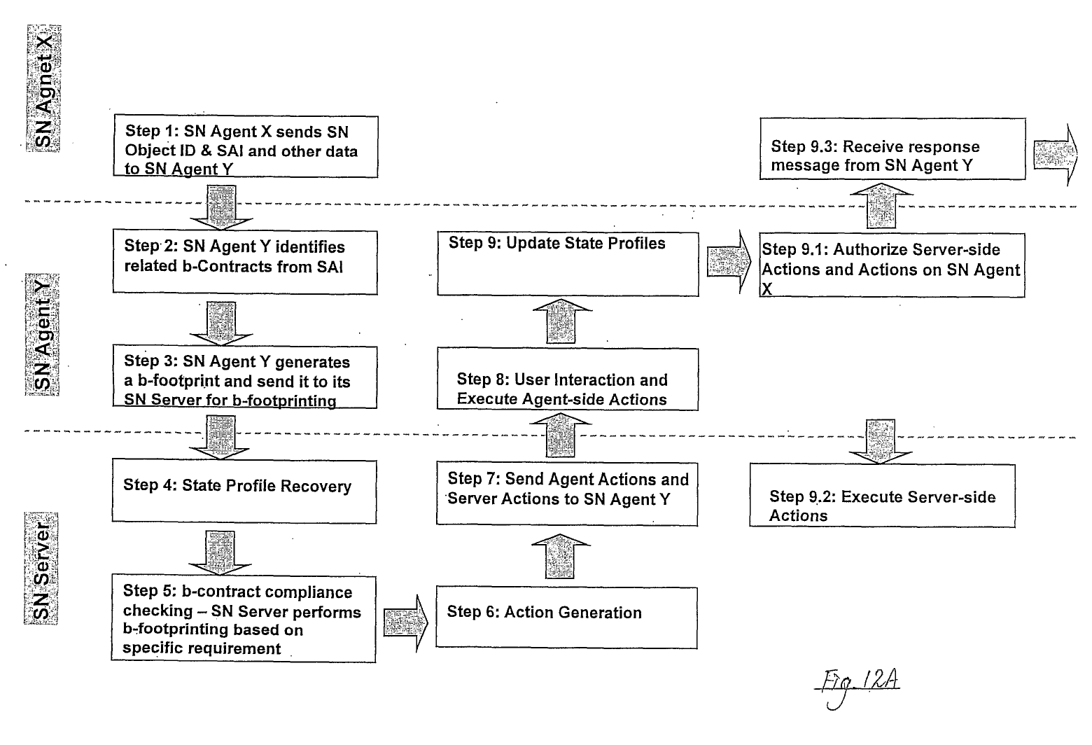

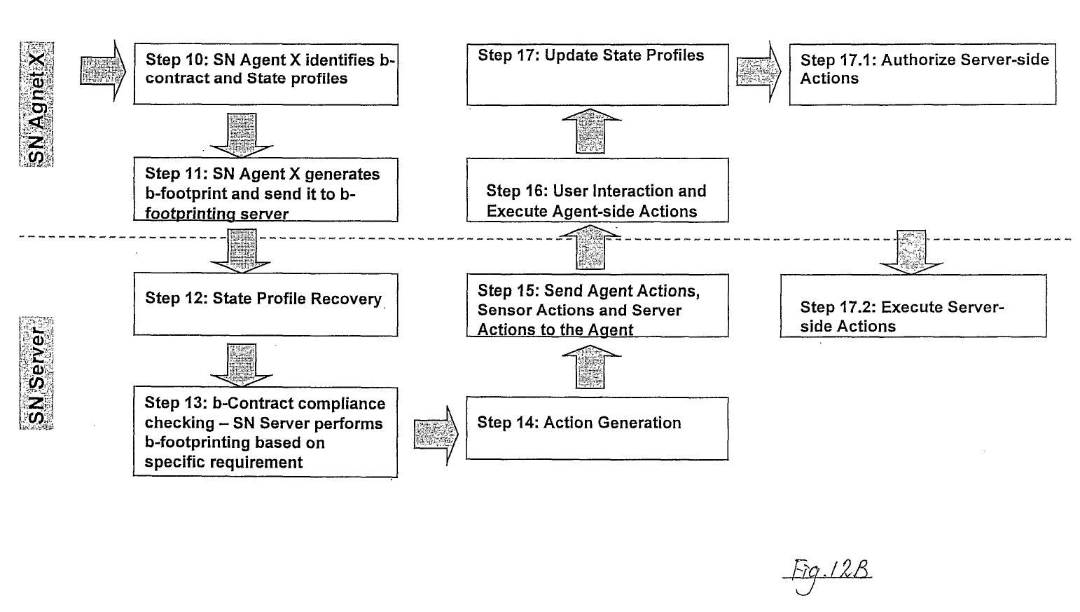

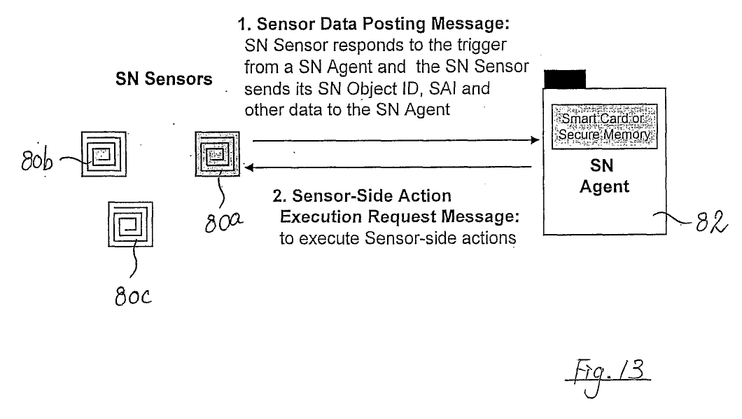

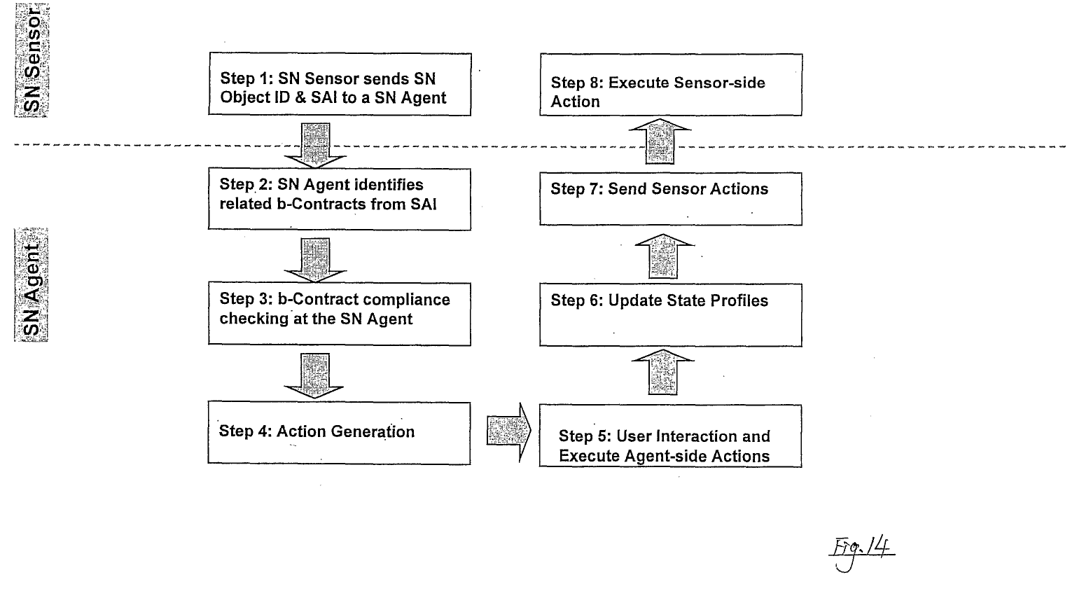

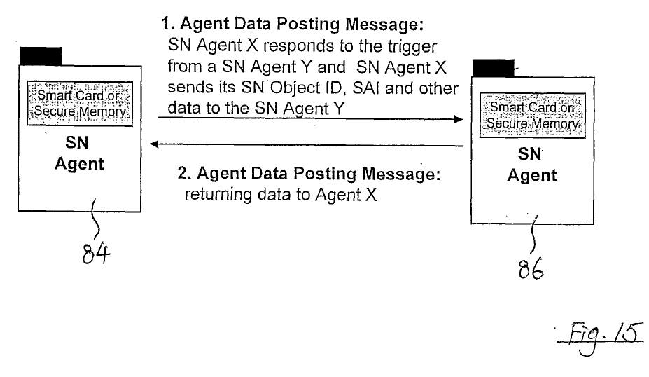

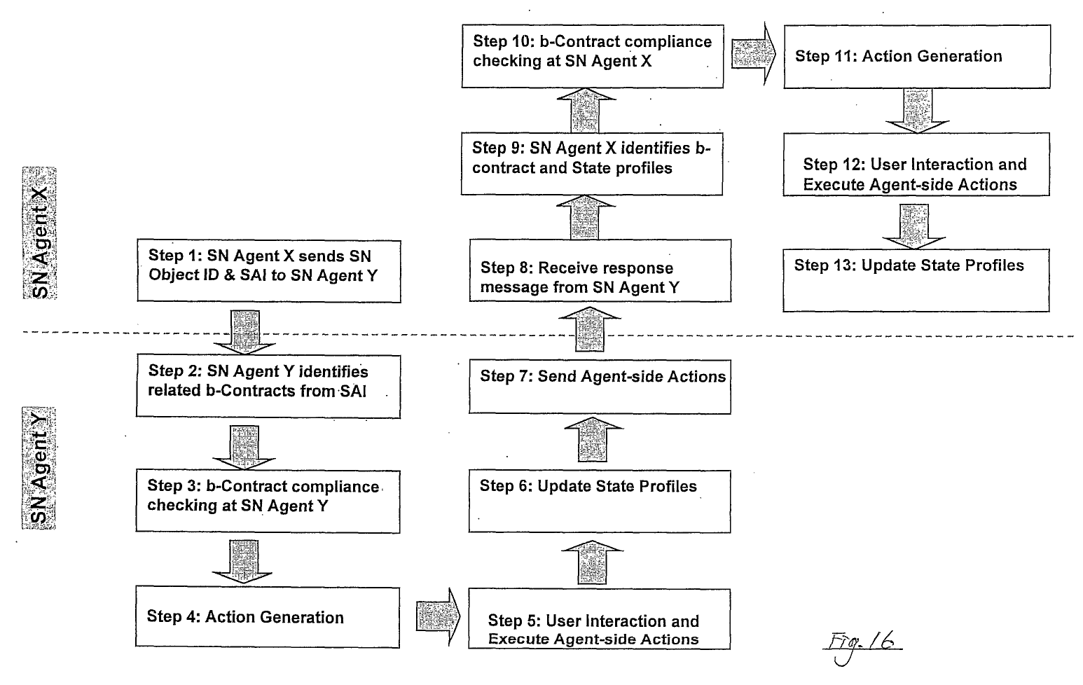

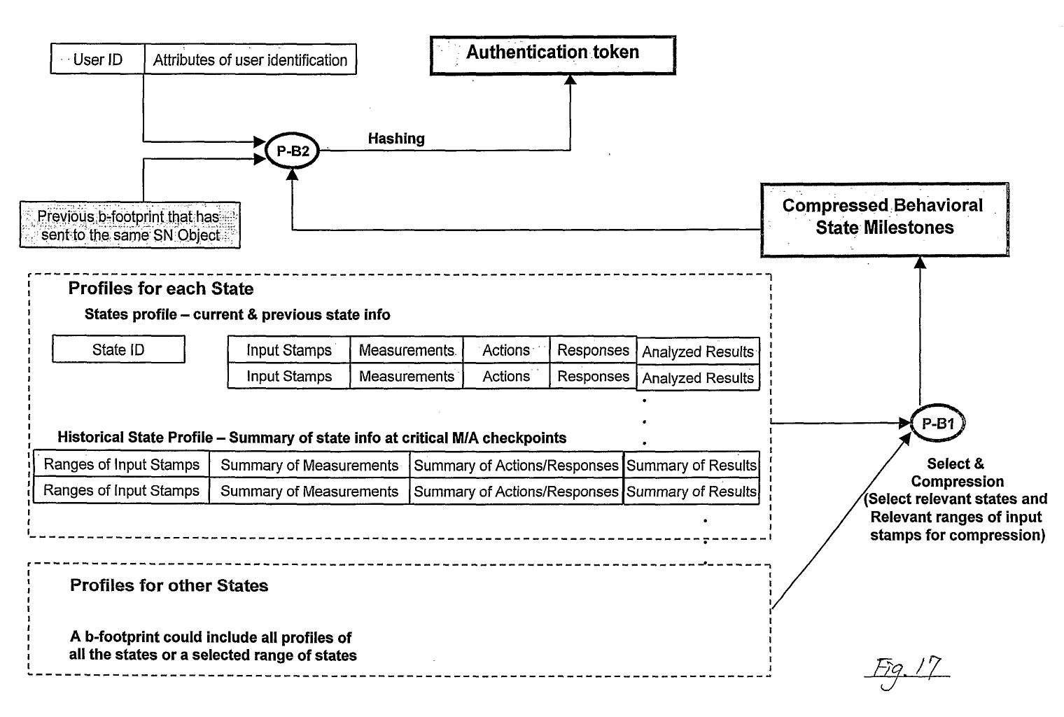

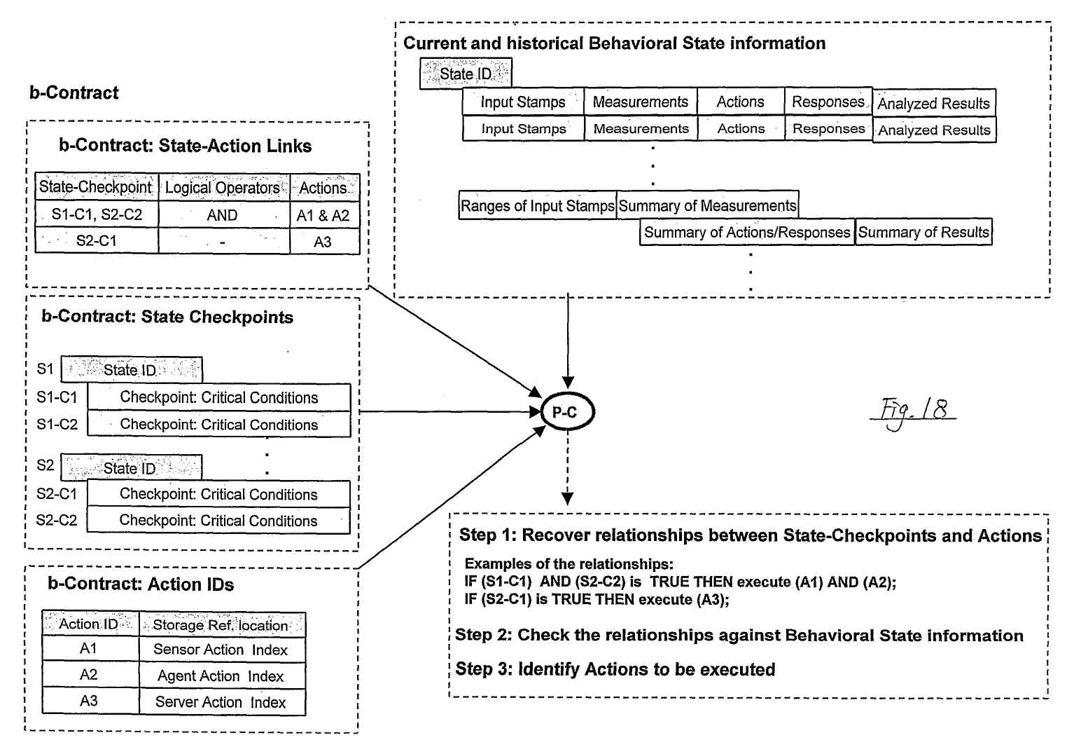

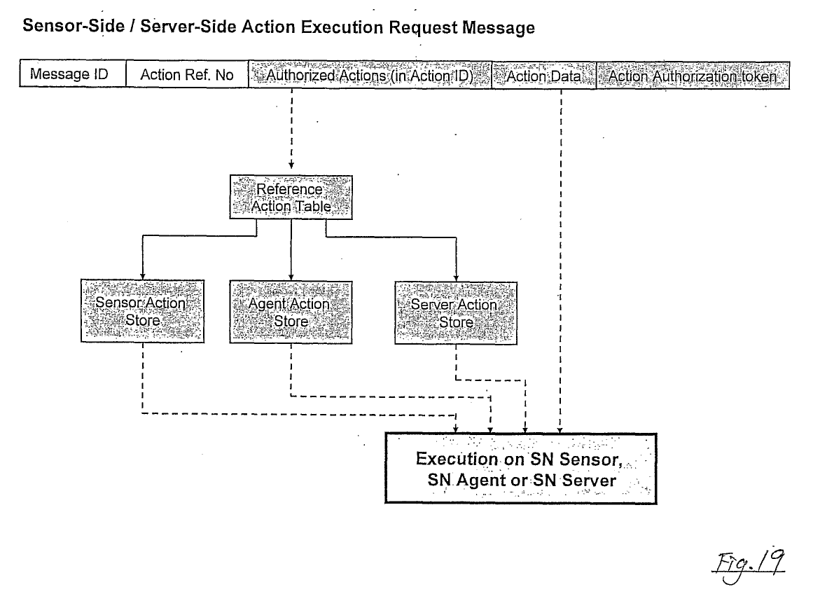

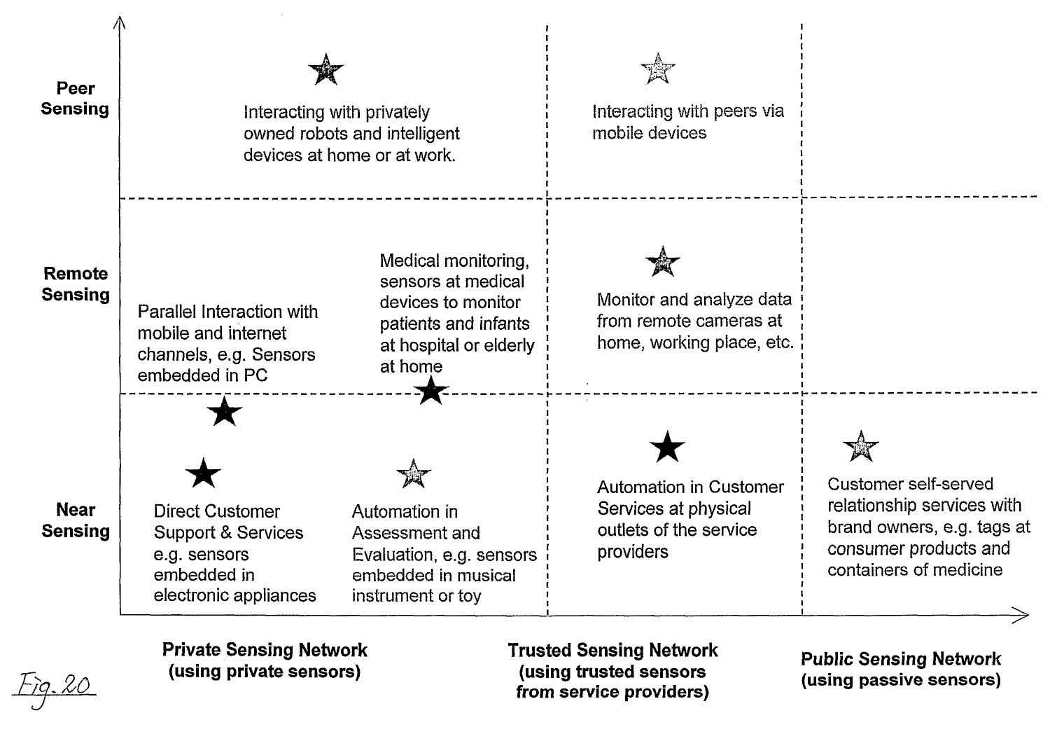

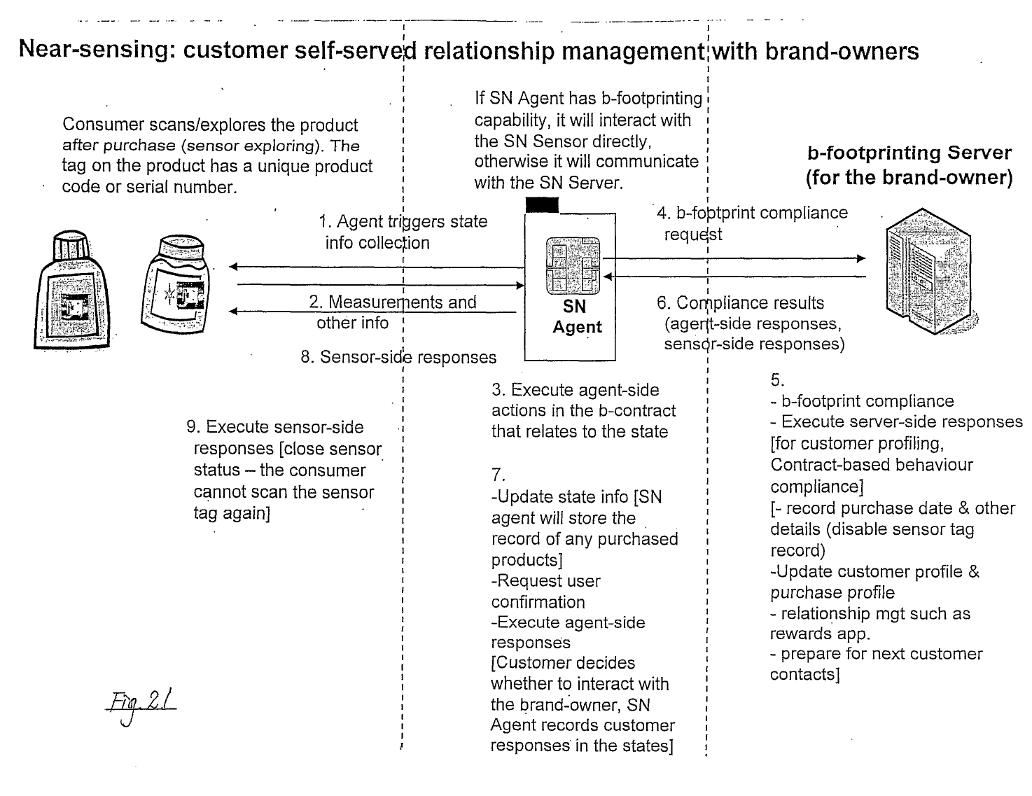

As shown in FIG. 2, a Behavioral State contains information as shown in the following Table 1:

TABLE 1
The Basic Data Elements of a Behavioral State

| S/N | Data Elements | Fields | Description |
|---|---|---|---|
| 1 | Input Stamps | Time stamp | The time that the measurement was taken. |
| | | Location stamp | The location that the measurement was |
| | | | taken. A location detection function is |
| | | | required in the mobile device to capture |
| | | | the location of the SN Object. |
| | | SN Object ID | The identification of the SN Object. |
| | | stamp | |
| 2 | Measurements | Text-based data | Text-based data recorded from the SN |
| | | records | Object. |
| | | Related multimedia | Snapshots of video stream, audio |
| | | Information | stream or multimedia photo depending |
| | | Snapshots | on the types of applications |
| 3 | SN Object | Agent Actions | It stores the actions taken by related SN |
| | Actions | | Agent during the instant of interaction. |
| | | Server Actions | It stores the actions taken by related SN |
| | | | Server during the instant of interaction. |
| | | Sensor Actions | It stores the actions taken by related SN |
| | | | Sensor during the instant of interaction. |
| 4 | User Responses | Responses from the | During the instant of interaction, the |
| | | user | user responds to the actions of the |
| | | | related SN Objects. These responses are |
| | | | recorded by the SN Agent and stored in |
| | | | this field. |
| 5 | Analyzed | Results after the | Analyzed results such as results from |
| | Results | process of | scoring algorithms could be recorded in |
| | | Behavioral | the state. These results are generated |
| | | footprinting | either by the SN Agent or SN Server |
| | | | that perform Behavioral footprinting |
| | | | based on the measurements of the state. |

As shown in FIG. 3, a group of SN Objects can form a Private Sensing Network (i.e. a sensing network in which all SN Objects are related to one SN Agent). In this example, the SN Sensor and SN Agent are privately owned by a user and the user has engaged a service from the SN Server.

The SN Object in this network/system is an RF sensor 32 that links to the monitoring system in a car 34 that records the utilization rate of certain parts of the car 34. The SN Agent is the software that is runs in the USIM/SIM card of a mobile phone 36 with NFC (Near Field Communication) capabilities. The SN Server is a service portal 38 that provides a monitoring service on behalf of the manufacturer of the car 34. The SN Agent communicates with the SN Sensor via contactless communication technology, such as NFC, and with the SN Server via mobile communication technology, such as GPRS.

In this example, the types of information related to the Behavioral States of the SN Agent in this Private Sensing Network include:
Behavioral State: Utilization Rate
Input Stamps: time of taking the measurement, location of the SN Agent when the measurement was taken, ID of the RF sensor in the car
Measurements: levels of utilization rate of different parts of the car, for example, the pressure of the wheel tyres and the liquid levels of the water tank
SN Object Actions: SN Server recommends to SN Agent (the user) to make an urgent check-up appointment with the garage
User Responses: Request for an appointment with the garage recommended by the car manufacturer
Analyzed Results: The condition of operation has changed to unacceptable condition.

As SN Agents interact with other SN Objects in a Sensing Network, the information in Behavioral States grows continuously. As the memory capacity in a Personal Hardware Token that hosts an SN Agent can be fairly limited, there is a need to reduce the memory storage of Behavioral States periodically.

An algorithm to convert Behavioral States into historical summary of Behavioral States is shown in FIG. 4, and described below.

P-A: Converting Behavioral States into Historical State Profiles
Step 1: For each Behavioral State, identify the critical checkpoints of measurements/attributes from its related Behavioral Contracts.
Step 2: Identify a time window of State records (or historical State records). The choice of the time window depends on the memory capacity that is available.
Step 3: Generate the ranges of input stamps based on the value of the time window
Step 4: Generate a summary of measurements within the window based on the critical checkpoints of measurements/attributes. This process could be a statistical summary on text-based data or a selection of multimedia information based on specific criteria
Step 5: Generate a summary of actions/responses within the window based on the critical checkpoints of measurements/attributes. This process can be a selection of multimedia information based on specific criteria
Step 6: Generate a summary of analyzed results within the window based on the critical checkpoints of measurements/attributes. This process can be a statistical summary on text-based data or a selection of multimedia information based on specific criteria
Step 7: Generate a historical state profile based on the output of Steps 2-6
Step 8: Remove the State records (or historical State records) within the time window from the memory

It is possible to have multiple levels of historical summary State records stored in a SN Object. P-A Algorithm can be applied on different levels of historical summary State records to generate a higher level of summary State records, also as shown in FIG. 4.

During interactions between SN Objects, actions will be executed as requests or responses. It is typical to have multiple SN Objects involved in an interaction. Therefore, the actions of SN Objects are dynamic and interactive. In addition, the actions are closely related to the information stored in the Behavioral States of the SN Objects.

A control mechanism is thus introduced for all the SN Objects involved in the interaction to follow. The mechanism to manage this kind of multi-party interaction is based on an electronic form of contract that defines all the information required to bind the interactions among SN objects. SN objects are required to respond to other SN objects based on the contents in the contract and the Behavioral States that are related to the contract. This electronic form of contract is herein called Behavioral Contract (b-Contract).

FIG. 5 shows a hierarchy of associations. First of all, a user 40 can be associated with multiple sensing applications 42, 44 and the sensing applications can be associated with multiple b-Contracts, as in this example the sensing application 42 is associated with two b-Contracts 46, 48.

Each b-Contract can in turn be associated with one or more SN Objects. In this example, the b-Contract 46 is associated with two SN Objects 50, 52. Each SN Object has its own respective Behavioral States.

It is also possible that one SN Object is being associated with more than one b-Contract. Therefore, the information in the Behavioral States of an SN Object can also be referenced by more than one b-Contract.

An Association Table for SN Objects and b-Contracts is required to maintain the associations between SN Objects and b-Contracts.

If a b-Contract is not associated to any specific SN Object, it will then be associated to a default SN Object, which may be an SN Server that can create a new association to another SN Object dynamically at runtime based on the context of the situation.

FIG. 6 shows an example of how b-Contracts relate to SN Objects in a Sensing Network. In this example, SN Sensor 54, SN Agents 56, 58 and SN Server 60 are associated with b-Contract A. Therefore b-Contract A defines the details required for the interactions among them.

As for SN Sensor 54, SN Agent 58 and SN Server 62, they are associated with b-Contract B. In other words, they will interact based on the details of b-Contract B.

In this scenario, the SN Sensor 54 and the SN Agent 58 are associated with both b-Contract A and b-Contract B, whereas the other SN Objects are only associated with one of the b-Contracts.

Tailor-made b-Contracts will be downloaded to the personal hardware token whenever the user subscribes to a new sensing application from a service provider. The service provider will work out the details of the b-Contract with individual users during the process of application registration. Based on the information from the Behavioral States, the service provider could also generate a new tailor-made b-Contract for the user to accept.

FIG. 7 shows the data elements of a b-Contract. Each b-Contract defines the contractual behavioral information of all SN Objects involved. The basic data elements of each b-Contract are as shown in Table 2 below:

TABLE 2
The Basic Data Elements of a Behavioral Contract

| S/N | Data Elements | Description |
|---|---|---|
| 1 | b-Contract ID | An identification to uniquely identify the |
| | | b-Contract |
| 2 | b-Contract | A b-Contract consists of multiple record entries |
| | Records | for associated SN Objects. There is one |
| | | b-Contract record entry for each associated SN |
| | | Object. |

For each SN Object, a b-Contract consists of three parts. The information of b-Contract in Part I stores the static information related to the specific SN Object and the b-Contract, as shown in Table 3 below:

TABLE 3
Data elements of b-Contract record entry for each associated SN Object:
Part I - Reference Information

| S/N | Data Elements | Fields | Description |
|---|---|---|---|
| 1 | SN Object ID | Unique ID for the | This is the reference ID of the SN Object |
| | | Sensing Network | that is associated with the b-Contract. |
| | | Object | |
| 2 | Reference | Configurations of | Define the type and capabilities of the |
| | Tables | related Sensing | related SN Objects in the b-Contract. |
| | | Network Objects | One of the key information is the SN |
| | | | Object ID of the SN Server that is |
| | | | associated with the SN Agent. The SN |
| | | | Server will perform Behavioral footprinting |
| | | | for the SN Agent |
| | | Key Table | Keys for authorization and integrity check |
| | | Definition Index | Indices of the memory location that |
| | | Table | stores the definitions of the attributes of |
| | | | the behavioral states in the b-Contract. |

The information of b-Contract in Part II stores the information required for preliminary checking of compliance of the b-Contract such as the expiry date checking of the b-Contract, as shown in Table 4 below:

TABLE 4
Data elements of b-Contract record entry for each associated SN Object:
Part II - Information for pre-behavioral compliance checking

| S/N | Data Elements | Fields | Description |
|---|---|---|---|
| 3 | Boundary | Communication | This field defines the legal |
| | Conditions | control | communication data type, data |
| | | | size and content screening |
| | | | between SN objects. |
| | | Boundaries for | Activation time/date |
| | | Time | Expiry time/date |
| | | Boundaries for | Locations for measurements |
| | | Location | |
| | | Access Right | The right for accessing the |
| | | Table | data by a specific SN Object. |
| | | | E.g. A b-Contract defines how |
| | | | SN Object peers share data |
| | | | (or files) among peers. |

The information of b-Contract in Part III stores the information required for detailed Behavioral State compliance checking, as shown in Table 5 below:

TABLE 5
Data elements of b-Contract record entry for each associated SN Object:
Part III - Information for behavioral compliance checking

| S/N | Data Elements | Fields | Description |
|---|---|---|---|
| 4 | State | Behavioral State ID | Unique IDs of the Behavioral States |
| | Checkpoints | | that is associated to the SN Object. |
| | | Checkpoint: | The critical conditions of behavioral |
| | | Critical Conditions | states upon which actions are required |
| | | for measurements | to be triggered as a response. |
| 5 | Action Indices | Action ID | Unique IDs of possible Actions |
| | | Storage Reference | Indices that relate to the physical |
| | | Location | storage locations of the actions. There are |
| | | | 3 sets of indices: |
| | | | 1. sensor action indices |
| | | | 2. agent action indices |
| | | | 3. server action indices |
| 6 | State-Action | State-Checkpoint | Associations of State IDs and |
| | Links | | Checkpoint IDs |
| | | Logical operators | Logical operators that links the State- |
| | | | Checkpoints and Actions |
| | | Action IDs | Unique IDs of possible Actions |

FIG. 8 shows examples of State-Action Links, State Checkpoints and Action IDs. An SN object will not need to take any action corresponding to the change of value in a behavioral state. It only needs to take action when the behavioral state changes to an “interesting” status.

A checkpoint of a Behavioral State is defined as the condition of the state that triggers actions of the SN objects involved. For example, a critical condition is reached when certain value of the attribute in a Behavioral State hits certain threshold levels and/or the occurrence of specific values of the attribute show statistical importance. Actions will be triggered if any of the checkpoints is activated.

An SN object will not execute any codes directly received from another SN object. Instead, the SN Object relates the Action ID to the physical location of the scripts or applets that are preloaded into its memory when the user subscribes to a new sensing application. State-Action Links realize the relationship between Actions and State Checkpoints. State Checkpoints in the State-Action Links could come from different Behavioral States of the different SN Objects.

The fields shown in Table 6 below are the basic data elements stored in an SN Agent. These data elements support the execution of the Behavioral footprinting process to be discussed in detail below.

TABLE 6
Data Elements of a SN Agent

| S/N | Data Elements | Fields | Description |
|---|---|---|---|
| 1 | Identification | ID and identification | Unique ID to represent the |
| | of the user | attributes of the user | identification of the user |
| | | who owns the SN | Identification of the user such as |
| | | Agent | biometrics of the user |
| 2 | Indexing table | Sensing Application | To define how SAI relates to States, |
| | of Sensing | Identifier (SAI) | SN Objects and b-contracts |
| | Application | b-Contract ID | An SN Agent could identify the |
| | Identifier | | corresponding b-Contract based on |
| | | | the b-Contract ID. Related Behavioral |
| | | | States could then be identified from |
| | | | the b-Contract ID. |
| 3 | b-Contracts | | Behavioral Contracts associated to |
| | | | the sensing applications that being |
| | | | sign-up by the user |
| 4 | Association | | To maintain the associations between |
| | table for SN | | SN Objects and b-Contracts. This |
| | Objects and b- | | table will be accessed to check |
| | Contracts | | whether there is a need to cross check |
| | | | other b-Contracts during b-Contract |
| | | | compliance checking |
| 5 | Behavioral | | Behavioral States related to the SN Agent |
| | States | | |
| 6 | Agent Action | | It stores the physical scripts or applets |
| | Store | | that could be executed in the Agent. |

To respond to information sent from an SN object, it is important to do on-the-fly analysis based on the current and previous values of the Behavioral States of the SN object. Reacting with actions will require understanding of how SN objects should interact.

Behavioral footprinting (b-footprinting) is a method to check whether the SN Objects being associated with a b-Contract interact based on the details of the b-Contract.

In the process of b-footprinting, suitable actions will be proposed and the user can then confirm the execution (reject or accept) of actions. Upon confirmation by the user, the actions will be executed at the SN Objects involved in the b-Contract.

Due to the differences in hardware and software capabilities of the Personal Hardware Token that hosts the SN Agent, it is possible to have two classes of SN Agents:
(1) SN Agent which does b-footprinting with the help of its related SN Server;
(2) SN Agent which is fully capable of doing b-footprinting without the help of a SN Server.

There are four typical types of interactions between SN Objects during b-footprinting:

1. Sensor-Agent-Server Interaction

2. Agent-Agent-Server Interaction

3. Sensor-Agent Interaction

4. Agent-Agent Interaction

In addition to the above interactions, it is possible to have scenarios that involve other interactions. However the other interactions are just slight variations of the above interactions.

For the first two types, the SN Agent does b-footprinting with the help of its related SN Server. As for the last two cases, the SN Agents are capable of doing b-footprinting without the help of an SN Server.

FIG. 9 shows a scenario of Sensor-Agent-Server Interaction. In this example, SN Sensors 66a, 66b, 66c are deployed to collect measurements from the environment. The SN Sensor 66a communicates with an SN Agent 68 when a user tries to put his/her mobile device in a close enough distance with the Sensor 66a. A contactless communication is then established between the SN Sensor 66a and the mobile device in which the SN Agent 68 is running. The SN Agent 68 will only interact with the SN Sensor 66a if the SN Sensor 66a is associated with the Agent 68 in a b-Contract.

In this scenario, the SN Agent 68 does not have the processing capability to handle the b-footprinting process. Therefore, it needs to work with an SN Server 70 that is defined in the b-Contract record entry to perform b-footprinting. The SN Agent 68 activates the interaction with the SN Server 70 through wireless communication and it is responsible for the coordination of communication between the SN Sensor 66a and the SN Server 70.

The SN Agent 68 will prompt a user for action confirmation. The user will play a key role in the interaction as he/she can reject or accept the actions based on the results of b-footprinting.

FIG. 10 shows the steps of b-footprinting during a Sensor-Agent-Server Interaction, as further elaborated in the Table 7 below.

TABLE 7

| Step | SN Object | Details of Interactions |
|---|---|---|
| 1 | SN Sensor | SN Sensor sends SN Object ID, SAI and other data |
| | | to an SN Agent |
| | | Upon triggering of a communication by an SN Agent |
| | | (after authentication), the SN Sensor prepares the data |
| | | for the SN Agent. The SN Sensor wraps the data to a |
| | | message and passes it to the communication tunnel. |
| | | The message is called Sensor Data Posting Message |
| | | which includes SN Object ID, Sensing Application |
| | | Identifier (SAI) and other relevant data. |
| 2 | SN Agent | SN Agent identifies related b-Contracts from SAI |
| | | The mobile device receives the message and passes it |
| | | to the SN Agent in the Personal Hardware Token such |
| | | as USIM/SIM card, secure flash card and multimedia |
| | | card. The SN Agent authenticates the message, and |
| | | checks its integrity. From the SAI in the message, it |
| | | identifies all related b-Contracts. |
| 3 | SN Agent | SN Agent generates a b-footprinting request and |
| | | send it to its SN Server |
| | | The SN Agent records the measurements from the |
| | | sensors. The SN Agent generates a b-footprint based |
| | | on the related b-Contracts. It then generates a b- |
| | | footprinting request to its related SN Server. The b- |
| | | footprinting request is sent to its SN Server for b- |
| | | footprinting. |
| 4 | SN Server | State Profile Recovery |
| | | The SN Server authenticates the message sending from |
| | | the SN Agent. It selects the target b-Contracts and |
| | | recovers the State Profile information in the b- |
| | | footprint. It then gets the current measurement metrics |
| | | by decompressing the compressed State Milestone |
| | | Profiles in the b-footprint. |
| 5 | SN Server | b-Contract compliance checking: b-footprinting |
| | | server performs b-footprinting based on specific |
| | | requirements |
| | | The SN Server performs b-Contract compliance |
| | | checking. |
| 6 | SN Server | Action Generation |
| | | The SN Server generates actions for its related SN |
| | | Sensors, Agents and Servers. The actions could be |
| | | analyzed results, requests for executable actions and |
| | | requests for accepting a new tailor-made b-Contract |
| | | generated by the SN Server. |
| 7 | SN Server | Send Agent Actions, Sensor Actions and Server |
| | | Actions to the Agent |
| | | The SN Server formats and sends all actions to Sensors |
| | | and Agents. |
| 8 | SN Agent | User Interaction and Execute Agent-side Actions |
| | | The SN Agent verifies the response message sent from |
| | | the SN Server. The SN Agent asks the user to confirm |
| | | the actions on Sensors, Agents and Servers. The user |
| | | has the right to confirm or reject the actions. Upon |
| | | confirmation from the user, the SN Agent triggers |
| | | Agent-side actions. The SN Agent may also ask the |
| | | user for interaction. The user responses could include: |
| | | Reply to requests |
| | | Reply to information notification |
| | | Reply to alerts |
| | | Suggestions for other actions |
| | | The SN Agent executes the Agent-side actions based |
| | | on the user responses. |
| 9 | SN Agent | Update State Profiles |
| | | The Agent updates its Behavioral State Profiles |
| | | according to: |
| | | Actions on Sensors, Agents and Servers |
| | | User responses (rejection or confirmation of the |
| | | action request and other data input by the user) |
| | | Analyzed results based on analysis such as scoring |
| | | algorithm carried out by the SN Server |
| 9.1 | SN Agent | Authorizes Server-side and Sensor-side Actions |
| | | The Agent authorizes the actions on the SN Servers |
| | | and SN Sensors, if any. |
| 9.2 | SN Server | Execute Server-side Actions |
| | | SN Server executes the actions sent from the |
| | | SN Agent. |
| | | Server-side actions could include actions for risk |
| | | management and profile analysis. |
| 9.3 | SN Sensor | Execute Sensor-side Actions |
| | | SN Sensor executes the actions sent from the SN |
| | | Agent. Sensor-side actions could include |
| | | disabling/enabling the operations of the sensor and |
| | | changes in operational configurations. |

FIG. 11 shows a scenario of Agent-Agent-Server Interaction. As a kind of peer-to-peer communication, any SN Agent can communicate with other SN Agent in a Sensing Network. However, an SN Agent will only interact with another SN Agent if the SN Agent is associated with it in a b-Contract.

An SN Agent can trigger the communication with another SN Agent by either using contactless or wireless communication.

In this scenario, it is assumed that both SN Agents 72, 74 do not have the processing capability to handle the b-footprinting process. Therefore, they need to work with their own respective SN Servers 76, 78 that are defined in the b-Contract record entry to perform b-footprinting. The SN Agents 72, 74 activate the interaction with their respective SN Server 76, 78 through wireless communication.

The SN Agents 72, 74 will prompt their respective user for action confirmation. The user will play a key role in the interaction as he/she could reject or accept the actions based on the results of b-footprinting.

FIGS. 12A and 12B combine to show the steps of b-footprinting during an Agent-Agent-Server Interaction, as further elaborated in the Table 8 below.

TABLE 8

| Step | SN Object | Details of Interactions |
|---|---|---|
| 1 | SN Agent X (the | SN Agent X sends SN Object ID & SAI to SN Agent Y |
| | initiating Agent) | Upon triggering of a communication by SN Agent X |
| | | after authentication, SN Agent X prepares the data for |
| | | SN Agent Y. SN Agent X wraps the data to a message |
| | | and passes it to the communication channel. The |
| | | message from SN Agent X is called Agent Data Posting |
| | | Message, which includes SN Object ID, Sensing |
| | | Application Identifier (SAI) and other relevant data. |
| 2 | SN Agent Y (the | SN Agent Y identifies related b-Contracts from SAI |
| | Agent that | The mobile device receives the message and passes it |
| | receives the | to SN Agent Y in the Personal Hardware Token. SN |
| | request) | Agent Y authenticates the message and checks its |
| | | integrity. Based on the SAI in the message, it identifies |
| | | all related b-Contracts. |
| 3 | SN Agent Y | SN Agent Y generates a b-footprinting request and |
| | | send it to its SN Server for b-footprinting |
| | | SN Agent Y records the measurements from SN Agent |
| | | X. SN Agent Y generates a b-footprint based on the |
| | | related b-Contracts. It then generates a b-footprinting |
| | | request to its related SN Server. The b-footprinting |
| | | request is sent to its SN Server for b-footprinting. |
| 4 | SN Server | State Profile Recovery |
| | | The SN Server authenticates the message sending |
| | | from SN Agent Y. It selects the target b-Contracts and |
| | | recovers the State Profile information inside the b- |
| | | footprint. It then gets the current measurement metrics |
| | | by decompressing the compressed State Milestone |
| | | Profiles in the b-footprint. |
| 5 | SN Server | b-Contract compliance checking: b-footprinting |
| | | server performs b-footprinting based on specific requirements |
| | | The SN Server performs b-Contract compliance |
| | | checking. |
| 6 | SN Server | Action Generation |
| | | The SN Server generates the actions for its related SN |
| | | Sensors, Agents and Servers. The actions could be |
| | | analyzed results, requests for executable actions and |
| | | requests for accepting a new tailor-made b-Contract |
| | | generated by the SN Server. |
| 7 | SN Server | Send Agent Actions and Server Actions to SN Agent Y |
| | | The SN Server formats and sends all actions to SN |
| | | Agent Y. |
| 8 | SN Agent Y | User Interaction and Execute Agent-side Actions |
| | | SN Agent Y verifies the response message sent from |
| | | the SN Server. |
| | | SN Agent Y asks the user to confirm the actions on |
| | | SN Agents Y & X and Servers. |
| | | Upon confirmation from the user, SN Agent Y |
| | | triggers Agent-side actions |
| | | SN Agent Y may also ask the user for interaction. |
| | | The user responses could include: |
| | | Reply to requests |
| | | Reply to user notification |
| | | Reply to alerts |
| | | Suggestions for other actions |
| | | SN Agent Y executes the Agent-side actions based |
| | | on the user responses |
| 9 | SN Agent Y | Update State Profiles |
| | | the Agent updates its Behavioral State Profiles based |
| | | on: |
| | | Actions on Sensors, Agents and Servers |
| | | User responses (reject or confirmation of the |
| | | action request and other data input by the user) |
| | | Analyzed results based on analysis such as |
| | | scoring algorithm carried out by the SN Server |
| 9.1 | SN Agent Y | Authorizes Server-side and Agent-side Actions |
| | | The Agent authorizes the actions on the SN Servers |
| | | and SN Agent X, if any |
| 9.2 | SN Server | Execute Server-side Actions |
| | | SN Server executes the actions sent from SN Agent Y. |
| | | Server-side actions could include actions for risk |
| | | management and profile analysis. |
| 9.3 | SN Agent X | Receive response message from SN Agent Y |
| | | SN Agent X receives message from SN Agent Y |
| 10 | SN Agent X (the | SN Agent X identifies related b-Contracts from |
| | initiating Agent) | SAI |
| | | The mobile device receives the message and passes |
| | | it to SN Agent X in the Personal Hardware Token |
| | | SN Agent X authenticates the message and check its |
| | | integrity |
| | | From the SAI in the message, it identifies all related |
| | | b-Contracts |
| 11 | SN Agent X | SN Agent X generates a b-footprinting request and |
| | | send it to its SN Server for b-footprinting |
| | | SN Agent X records the measurements from SN |
| | | Agent Y |
| | | SN Agent X generates a b-footprint based on the |
| | | related b-Contracts |
| | | It then generates a b-footprinting request to its |
| | | related SN Server |
| | | The b-footprinting request is sent to its SN Server |
| | | for b-footprinting |
| 12 | SN Server | State Profile Recovery |
| | | The SN Server authenticates the message sending |
| | | from SN Agent Y. It selects the target b-Contracts and |
| | | recovers the State Profile information inside the b- |
| | | footprint. It then gets the current measurement metrics |
| | | by decompressing the compressed State Milestone |
| | | Profiles in the b-footprint. |
| 13 | SN Server | b-Contract compliance checking —b-footprinting |
| | | server performs b-footprinting based on specific |
| | | requirements |
| | | The SN Server performs b-Contract compliance |
| | | checking. |
| 14 | SN Server | Action Generation |
| | | The SN Server generates the actions for its related SN |
| | | Sensors, Agents and Servers. The actions could be |
| | | analyzed results, requests for executable actions and |
| | | requests for accepting a new tailor-made b-Contract |
| | | generated by the SN Server. |
| 15 | SN Server | Send Agent Actions and Server Actions to SN Agent X |
| | | The SN Server formats and sends all actions to SN |
| | | Agent X |
| 16 | SN Agent X | User Interaction and Execute Agent-side Actions |
| | | SN Agent X verifies the response message sent from |
| | | the SN Server |
| | | SN Agent X asks the user to confirm actions on SN |
| | | Agent X and Servers |
| | | Upon confirmation from the user, SN Agent X |
| | | triggers Agent-side actions |
| | | SN Agent X may also ask the user for interaction. |
| | | The user responses could include: |
| | | Reply to requests |
| | | Reply to user notification |
| | | Reply to alerts |
| | | Suggestions for other actions |
| | | SN Agent X executes the Agent-side Actions based |
| | | on the user responses |
| 17 | SN Agent X | Update State Profiles |
| | | The Agent updates its Behavioral State Profiles |
| | | based on: |
| | | Actions on Sensors, Agents and Servers |
| | | User responses (reject or confirmation of the |
| | | action request and other data input by the user) |
| | | Analyzed results based on analysis such as |
| | | scoring algorithm carried out by the SN Server |
| 17.1 | SN Agent X | Authorizes Server-side and Agent-side Actions |
| | | The Agent authorizes the actions on the SN Servers, if |
| | | any. |
| 17.2 | SN Server | Execute Server-side Actions |
| | | SN Server executes the actions sent from SN Agent X. |
| | | Server-side actions could include actions for risk |
| | | management and profile analysis. |

FIG. 13 shows a scenario of Sensor-Agent Interaction. In this scenario, SN Sensors 80a, 80b, 80c are deployed to collect measurements from the environment. An SN Sensor 82 communicates with an SN Agent 80a when a user tries to put his/her mobile device in a close distance with the Sensor 80a. A contactless communication is then established between the SN Sensor 80a and the mobile device in which the SN Agent 82 is running. The SN Agent 82 will only interact with the SN Sensor 80a if the SN Sensor 80a is associated with the Agent 82 in a b-Contract.

In this scenario, the SN Agent 82 is taken to have the full and sufficient processing capability to handle the b-footprinting process. b-footprinting is performed by the SN Agent 82.

FIG. 14 shows the steps of b-footprinting during a Sensor-Agent Interaction, as further elaborated in the Table 9 below.

TABLE 9

| Step | SN Object | Details of Interactions |
|---|---|---|
| 1 | SN Sensor | SN Sensor sends SN Object ID & SAI to a SN |
| | | Agent |
| | | Upon triggering of a communication by a SN Agent |
| | | after authentication, the SN Sensor prepares the data |
| | | for the SN Agent. The SN Sensor wraps the data to a |
| | | message and passes it to the communication tunnel. |
| | | The message is called Sensor Data Posting Message, |
| | | which includes SN Object ID, Sensing Application |
| | | Identifier (SAI) and other relevant data. |
| 2 | SN Agent | SN Agent identifies related b-Contracts from SAI |
| | | The mobile device receives the message and passes |
| | | it to the SN Agent in the Personal Hardware Token. |
| | | The SN Agent authenticates the message and check |
| | | its integrity. |
| | | From the SAI in the message, it identifies all related |
| | | b-Contracts. |
| | | The SN Agent also records the measurements from |
| | | the sensors. |
| 3 | SN Agent | b-Contract compliance checking at the SN Agent |
| | | The SN Agent performs b-Contract compliance |
| | | checking. |
| 4 | SN Agent | Action Generation |
| | | The SN Agent generates actions for its related SN |
| | | Sensors and Agents. The actions could be analyzed |
| | | results, requests for executable actions and requests for |
| | | accepting a new tailor-made b-Contract generated by |
| | | the SN Agent. |
| 5 | SN Agent | User Interaction and Execute Agent-side Actions |
| | | The SN Agent asks the user to confirm actions on |
| | | the SN Sensors and Agents |
| | | Upon confirmation from the user, the SN Agent |
| | | triggers Agent-side actions |
| | | The SN Agent may also ask the user for interaction. |
| | | The user responses could include: |
| | | Reply to requests |
| | | Reply to user notification |
| | | Reply to alerts |
| | | Suggestions for other actions |
| | | The SN Agent executes the Agent-side actions based |
| | | on the user responses |
| 6 | SN Agent | Update State Profiles |
| | | The Agent updates its Behavioral State Profiles |
| | | based on: |
| | | Actions on Sensors, Agents and Servers |
| | | User responses (reject or confirmation of the |
| | | action request and other data input by the user) |
| | | Analyzed results based on analysis such as |
| | | scoring algorithm carried out by itself |
| 7 | SN Agent | Send Sensor-side Actions |
| | | The SN Agent sends the actions to the SN Sensors, if |
| | | any. |
| 8 | SN Sensor | Execute Sensor-side Actions |
| | | SN Sensor executes the actions sent from the SN |
| | | Agent. Sensor-side Actions could include |
| | | disabling/enabling and changes in operational |
| | | configurations. |

FIG. 15 shows a scenario of Agent-Agent Interaction. As a kind of peer-to-peer communication, any SN Agent can communicate with other SN Agent in a sensing network. However, an SN Agent will only interact with another SN Agent if the SN Agent is associated with it in a b-Contract. An SN Agent can trigger communication with another SN Agent by using either contactless or wireless communication.

In the scenario as shown in FIG. 15, both SN Agents 84, 86 are assumed to have the full and sufficient processing capability to handle the b-footprinting process. b-footprinting is performed by the SN Agents 84, 86.

FIG. 16 shows the steps of b-footprinting during an Agent-Agent Interaction, as further elaborated in the Table 10 below.

TABLE 10

| Step | SN Object | Details of Interactions |
|---|---|---|
| 1 | SN Agent X (the | SN Agent X sends SN Object ID & SAI to SN |
| | initiating Agent) | Agent Y |
| | | Upon triggering of a communication by SN Agent X |
| | | after authentication, SN Agent X prepares the data for |
| | | SN Agent Y. SN Agent X wraps the data to a message |
| | | and passes it to the communication tunnel. The |
| | | message from SN Agent X is called Agent Data |
| | | Posting Message, which includes SN Object ID, |
| | | Sensing Application Identifier (SAI) and other |
| | | relevant data. |
| 2 | SN Agent Y (the | SN Agent Y identifies related b-Contracts from |
| | Agent that | SAI |
| | receives the | The mobile device receives the message and passes |
| | request) | it to SN Agent Y in the Personal Hardware Token. |
| | | SN Agent Y authenticates the message and check its integrity. |
| | | From the SAI in the message, it identifies all related |
| | | b-Contracts. |
| | | SN Agent Y records the measurements from SN Agent X. |
| 3 | SN Agent Y | b-Contract compliance checking at SN Agent Y |
| | | SN Agent Y performs b-Contract compliance |
| | | checking. |
| 4 | SN Agent Y | Action Generation |
| | | SN Agent Y generates the actions for its related SN |
| | | Sensors and Agents. The actions could be analyzed |
| | | results, requests for executable actions or requests for |
| | | accepting a new b-Contract by SN Agent Y. |
| 5 | SN Agent Y | User Interaction and Execute Agent-side Actions |
| | | SN Agent Y asks the user to confirm actions on SN |
| | | Agents Y & X. |
| | | Upon confirmation from the user, SN Agent Y |
| | | triggers Agent-side actions. |
| | | SN Agent Y may also ask the user for interaction. |
| | | The user responses could include: |
| | | Reply to requests |
| | | Reply to user notification |
| | | Reply to alerts |
| | | Acceptance of a new b-Contract |
| | | Suggestions for other actions |
| | | SN Agent Y executes the Agent-side actions based |
| | | on the user responses. |
| 6 | SN Agent Y | Update State Profiles |
| | | the Agent updates its Behavioral State Profiles based |
| | | on: |
| | | Actions on Agents |
| | | User responses (reject or confirmation of the |
| | | action request and other data input by the user) |
| | | Analyzed results based on analysis such as |
| | | scoring algorithm carried out by itself |
| 7 | SN Agent Y | Send Agent-side Actions to SN Agent X |
| | | SN Agent Y sends the actions to SN Agent X, if any. |
| 8 | SN Agent X | Receive response message from SN Agent Y |
| | | SN Agent X receives the message from SN Agent Y. |
| 9 | SN Agent X (the | SN Agent X identifies related b-Contracts from |
| | initiating Agent) | SAI |
| | | The mobile device receives the message and passes |
| | | it to SN Agent X in the Personal Hardware Token |
| | | SN Agent X authenticates the message and check its |
| | | integrity |
| | | From the SAI in the message, it identifies all related |
| | | b-Contracts |
| 10 | SN Agent X | b-Contract compliance checking at SN Agent X |
| | | SN Agent X performs b-Contract compliance |
| | | checking. |
| 11 | SN Agent X | Action Generation |
| | | SN Agent X generates the actions for its related SN |
| | | Agents. The actions could be analyzed results, |
| | | requests for executable actions and requests for |
| | | accepting a new tailor-made b-Contract generated by |
| | | the SN Agent X. |
| 12 | SN Agent X | User Interaction and Execute Agent-side Actions |
| | | SN Agent X asks the user to confirm Actions on SN |
| | | Agent X |
| | | Upon confirmation from the user, SN Agent X |
| | | triggers Agent-side actions |
| | | SN Agent X may also ask the user for interaction. |
| | | The user responses could include: |
| | | Reply to requests |
| | | Reply to user notification |
| | | Reply to alerts |
| | | Suggestions for other actions |
| | | SN Agent X executes the Agent-side actions based |
| | | on the user responses |
| 13 | SN Agent X | Update State Profiles |
| | | The Agent updates its Behavioral State Profiles |
| | | based on: |
| | | Actions on Agents |
| | | User responses (reject or confirmation of the |
| | | action request and other data input by the user) |
| | | Analyzed results based on analysis such as |
| | | scoring algorithm carried out by itself |

An SN Object initiates a communication session with an SN Agent by sending a Sensor Data Posting Message or Agent Data Posting Message. The fields of this message are shown in Table 11 below:

TABLE 11
Sensor Data Posting Message/Agent Data Posting Message
Sender: SN Sensor or SN Agent
Receiver: SN Agent

| S/N | Message Fields | Description |
|---|---|---|
| 1 | Message ID | To uniquely identify this message |
| 2 | SN Object ID | To uniquely identify the sender (a SN |
| | | Object) of the message |
| 3 | Sensing Application | To uniquely identify the sensing |
| | Identifier | application that associated with the |
| | | sender of the message |
| 4 | Sensor/Agent Data | The data that the sender wants to post to |
| | | the receiving SN Agent |
| 5 | Data for static | The data required for authentication and |
| | authentication & | integrity check |
| | integrity check | |

If the SN Agent does not have the processing capability to perform b-footprinting, it will send the information required for b-footprinting to its related SN Server.

The information required is called Behavioral footprint (b-footprint). b-footprint is a compacted data object that mainly consists of a selection of current and historical profiles of Behavioral States. A b-footprinting Request Message will then be sent to the SN Server by the SN Agent. The information of the Behavioral States can be restored by decompressing the b-footprint that is enclosed in the b-footprinting Request Message.

A b-footprinting Request Message consists of the data elements as shown in the following Table 12:

TABLE 12
b-footprinting Request Message
Sender: SN Agent
Receiver: SN Server

| S/N | Message Fields | Description |
|---|---|---|
| 1 | Message ID | To uniquely identify this message |
| 2 | SN Object ID | To uniquely identify the sender (a SN |
| | | Agent) of the message |
| 3 | b-Contract ID | To uniquely identify the b-Contract |
| | | involved |
| 4 | Time Stamp | The time of this message being generated |
| 5 | Behavioral Footprint | The compressed Behavioral States (refer |
| | (b-footprint) | to the Section on Generation of b- |
| | | footprint) |
| 6 | Authentication & | The data required for authentication and |
| | Integrity Token | integrity check |

FIG. 17 shows the steps of generation of compressed state profiles and authentication token in a b-footprinting request message.

Process P-B1: Generation of b-Footprint
Step 1: Identify all the Behavioral States that are described in the “State Checkpoints” of the associated b-Contract.
Step 2: For all the identified behavioral states:
   Step 2.1: Select the current and previous behavioral state information
   Step 2.2: Select the historical behavioral state information within a specific period of time (the time period is taken from the “Boundary Condition” field in the b-Contract)
Step 3: Compress all the selected behavioral state information using an effective lossless data compression algorithms compression algorithm such as “gzip”.

Process P-B2: Generation of the Authentication & Integrity Token in the b-Footprinting Request Message
Step 1: Prepare data element 1—current time stamp
Step 2: Prepare date element 2—user identification number and attributes of user identification
Step 3: Prepare data element 3—previous b-footprint that has been sent to the same SN Object, if any
Step 4: Prepare data element 4—output from Process P-B1
Step 5: Concatenate data elements 1, 2, 3 & 4
Step 6: The authentication and integrity token is generated by hashing the output of Step 5 using an effective and reliable hash algorithm such as SHA-224, SHA-256, SHA-384, and SHA-512

FIG. 18 shows b-Contract Compliance Checking. Behavioral contract compliance is part of b-footprinting and it is performed based on the information of Behavioral States in the local memory or restoring from b-footprint, that is the information about the measurements of the SN Objects from the environment and the history or records of the interactions among SN Objects.

The process of Behavioral Contract Compliance checks whether any SN Object has violated any pre-set rules and requirements defined in the b-Contract. It also suggests actions to be executed in related SN Sensors, SN Agents and SN Servers.

The associated b-Contract is checked against the state information and other supporting data from the related SN Object. The whole process consists of three phases:

First-Phase: Preparation for b-Contract Compliance
Step 1: Identify related associated b-Contract ID and SN Object ID. SN Object ID could be referring to a default SN Object if the b-Contract does not link to any specific SN Object
Step 2: Extract information from the Reference Tables in the b-Contract
Step 3: Examine the boundary conditions
Step 4: If there is no violation of any boundary conditions, execute the second-pass of b-Contract compliance, otherwise the compliance process will terminate.

Second-Phase: Compliance Check of a b-Contract—Process P-C
Step 1: Recover relationships between State and Actions based on State Checkpoints and State-Action Links in the b-Contract.
Step 2: Check the relationships against the Behavioral State information
Step 3: Identify actions that are required to execute at SN Sensors, SN Agents and SN Servers

Third-Phase: Cross-Checking on Other Associated b-Contracts

After the first two phases of the compliance check have finished for one associated b-Contract, the check will continue for another associated b-Contract until all associated b-Contracts have been examined. This cross-checking on other b-Contract is done based on the information in the association table for SN Objects and b-Contracts.

Actions are the responses of SN Objects to interactions based on the details defined in b-Contracts. Upon completion of b-Contract compliance, a list of Action IDs will be generated. The Action IDs refer to the logical addresses of the Action stores (memory locations) where the actual scripts or applets of the corresponding actions are stored.

If the compliance check is done by the SN Agent, the SN Agent will ask the user for response directly. If the compliance check is done by an SN Server, the SN Server needs to be informed of the actions. Due to security reasons, an SN Object will not execute any codes that are directly sent from another SN object during interaction. SN objects only execute the scripts or applets that have already been loaded into their local memory. Therefore, the output of b-Contract compliance only consists of Action IDs. These Action IDs will be posted to the SN Agent by the SN Server as an Action Data Posting Message (as below). The SN Agent can then ask the user for response.

The data elements of an Action Data Posting Message are shown in Table 13 below.

TABLE 13
Action Data Posting Message
Sender: SN Server
Receiver: SN Agent

| S/N | Message Fields | Description |
|---|---|---|
| 1 | Message ID | To uniquely identify this message |
| 2 | Action Reference | To uniquely identify the Actions that are |
| | Number | posted by the SN Server |
| 3 | Post Actions | The IDs of the actions that are posted by |
| | | the SN Server. Gather all action IDs and |
| | | arrange them in sequences |
| 4 | Action Data | Data sent by the SN Agent to support the |
| | | execution of the posted actions |
| 5 | Revised State Profiles | The revised information of the Behavioral |
| | | States that are involved in the b-Contract |
| 6 | Action Authentication | The data required for authentication. This |
| | Token | is used for authentication and audit trial |

The user can choose to accept or reject the actions that are being posted by the SN Server. The user can also adjust the details of the actions. The responses of the user will then be recorded in the corresponding Behavioral States of the SN Agent.

Upon receipt of confirming of the actions from the user, the SN Agent will execute the actions on itself and it will authorize the actions by sending a Sensor-Side or Server-Side Action Execution Request Message (as below) to SN Sensors and/or SN Servers. The data elements of a Sensor-Side/Server-Side Action Execution Request Message are shown in Table 14 below.

TABLE 14
Sensor-Side/Server-Side Action Execution Request Message
Sender: SN Agent
Receiver: SN Sensor or SN Server

| S/N | Message Fields | Description |
|---|---|---|
| 1 | Message ID | To uniquely identify this message |
| 2 | Action Reference | To uniquely identify the Actions that are |
| | Number | authorized by the SN Agent |
| 3 | Authorized Actions | The IDs of the actions that are authorized |
| | | by the SN Agent |
| 4 | Action Data | Data sent by the SN Agent to support the |
| | | execution of the authorized actions |
| 5 | Action Authorization | The data required for authentication |
| | Token | |

As further shown in FIG. 19, upon receiving the Action Execution Request Message, an SN Sensor or SN Server will identify the physical memory location of the actions from its Action Stores. The Scripts or applets of the actions will be executed together with the Action Data provided in the Action Execution Request Message.

It can be seen that, with the present invention, a human user can trust their personal hardware token to interact with physical objects and related distributed IT systems according to the pre-set rules. Sophisticated interactions are now possible and they can be realized as different forms of services such as marketing services, customer support and value-added services provided by the brand owners or manufacturers of the physical objects.

A human user can also trust their personal hardware token to interact with other personal hardware tokens. All the principles of interactions remain the same except that the dynamics of interactions will become more complex because either side can respond to the actions of the other side. The interactions can also involve multiple users concurrently.

FIG. 20 shows a matrix of possible applications of a method and a system according to the present invention. The various possible applications are distributed in the matrix according to (a) whether near sensing, remote sensing, or peer sensing is performed; and (b) whether a Private Sensing Network (using private sensors), a Trusted Sensing Network (using trusted sensors from service providers), or a Public Sensing Network (using passive sensors) is employed.

A method and system according to the present invention may be used for customer self-served relationship management with brand-owners. As shown in FIG. 21, a consumer may buy one or more consumable products of a certain brand from a retailer. The products are embedded with an RF tag/sensor (e.g. in the container of the product) having a unique product code or serial number. The consumer may bring an SN Agent, e.g. his/her mobile phone or PDA, close to the product to establish communication with the RF sensor in the product, e.g. for collecting state information relating to the product. The RF sensor then carries out the necessary checking for obtaining the required information. Such measurements and obtained information are then transmitted to the SN Agent. The SN Agent will then execute the agent-side actions in the relevant b-Contract that relates to the state.

If the SN Agent has b-footprinting capability, it will then interact with the SN Senor directly. If not, it will communicate with the SN Server. In the present case, assuming that the SN Agent does not have b-footprinting capability, such will then issue a b-footprinting request to the SN Server, which may be a server of the relevant brand-owner. The SN Server will then execute b-footprint compliance checking, and execute server-side responses, which may include updating customer profile and purchase profile, preparing for next customer contacts, etc.

Compliance results are then transmitted by the SN Server back to the SN Agent. The SN Agent then update state information, request user confirmation and execute agent-side responses. The compliance results may include analyzed results, requests for executable actions and requests for accepting a new tailor-made b-Contract generated by the SN Server. It should be noted that it is up to the consumer (i.e. the owner of the SN Agent) to decide whether to interact with the brand-owner, for which the SN Agent will record customer responses in the states. The sensor-side responses are then transmitted to the SN Sensor, which executes the sensor-side responses. In some situations, the sensor status may be closed, so that the consumer cannot scan the sensor tag in the product again. By way of such an arrangement, the consumer brand-owners can establish customer relationship services directly with the consumers, bypassing the distributors and retailers.

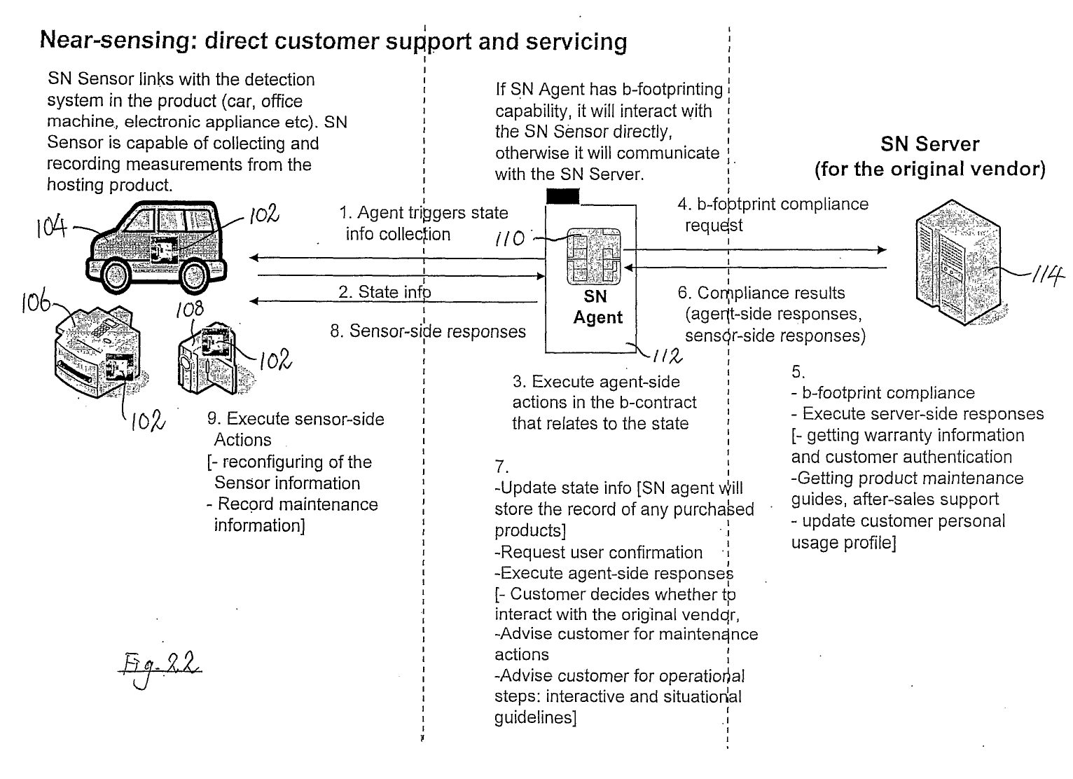

A method and system according to the present invention may also be used for direct customer support and servicing. As an example, and as shown in FIG. 22, a customer purchases an electronic appliance or machine, such as a automobile 104, a printer 106 or a video camera 108, each with a sensor 102 (RF or IR Sensors—SN Sensors) embedded onto it. The sensors 102 are also connected to the monitoring system of the hosting electronic appliance or machine.

The customer may then subscribe to a service provided by the brand owner of the appliance or machine through his/her mobile service provider. A b-Contract for the service provided by the brand owner will then be downloaded to the personal hardware token (SN Agent) of the user's mobile device. The b-Contract contains all the details of the service such as the service level agreement and all possible actions that can be taken by the customer.

The sensors 102 communicate with the software running on the user's personal hardware token (SN Agent) 110 when he/she tries to put his/her mobile device 112 in a close distance with the sensors 102. The software will also connect to its related IT servers (SN Servers) 114 provided by the brand owner of the electronic appliance or machine.

The user's mobile device can also be connected to the service portal or service provider's server for services, e.g. marketing services such as loyalty program, post-sales customer support services and other value-add services. The sensors 102 may collect data pertaining to the operational conditions of a car. The data will then be checked by the personal hardware token 110 and/or the servers 114 of the brand owner based on the contents of b-Contract via the process of b-footprinting. The outputs of this process are suggested actions to be executed on the sensors 102, personal hardware token 110 and/or the related servers 114 of the brand owner.

It can be seen that the above process allows the customer to interact with the sensors 102 and related IT systems for achieving non-trivial results. In the above example, the results of customer services can be monitoring of operational conditions of a car and suggestion for follow-on actions to the customers. Based on the service level agreement between the brand owner and the customer, the details of the services can be clearly defined in the b-Contract. With the above process, the sensors 102, the user and the brand owner need to act and react according to the b-Contract. In general, such allows customers to get connected to many interesting services directly from the brand owners of the products.

A system and method according to the present invention may also be employed in a virtual personal tutor service. The basic idea is to have sensors (RE or IR Sensors—SN Sensors) embedded into toys, machines or equipment, for training and assessment purposes. Such may, for example, be piano or other musical instruments. They are also connected to the monitoring system of the hosting equipment.

The sensors communicate with the software running on the personal hardware token (SN Agent) when a user tries to put his/her mobile device in a close distance with the sensors. This happens whenever the user wants to collect his record of performance from the equipment. The software on his/her mobile device will also connect to its related IT servers that are provided by a qualified assessment party for electronic evaluation.

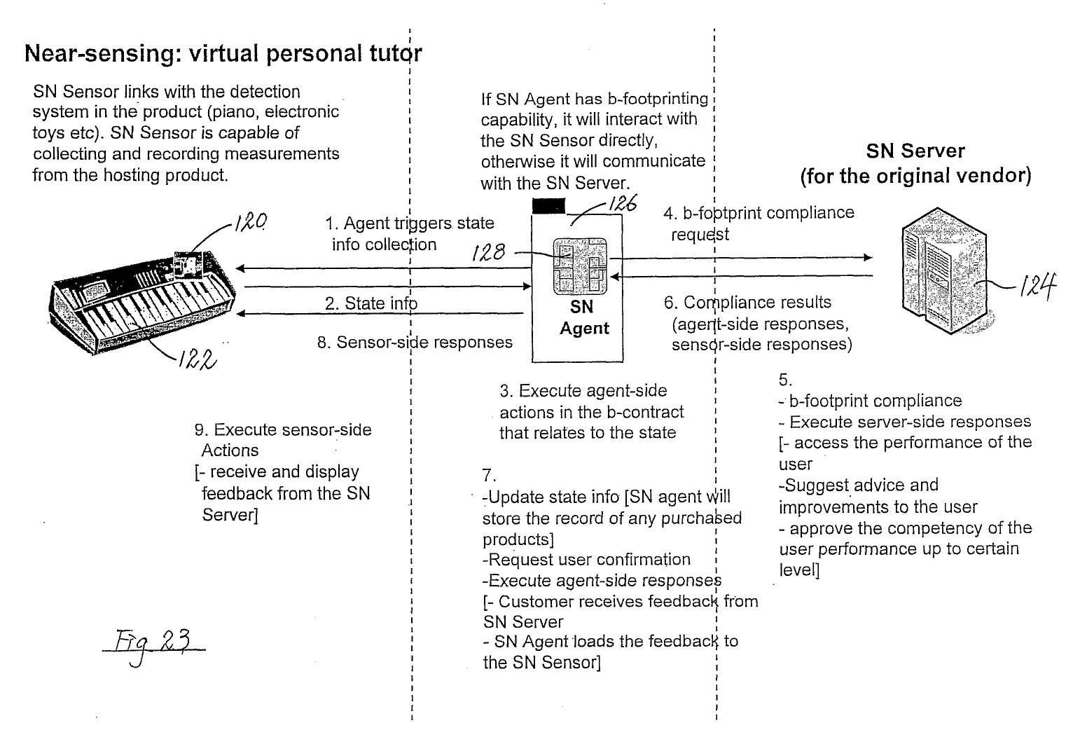

More particularly, and as shown in FIG. 23, a customer subscribes to a service for training or assessment provided by a qualified training or education provider, e.g. for assessment of piano-playing. A b-Contract for the training and assessment will be downloaded to the personal hardware token, e.g. USIM (Universal Subscriber Identification Module) or SIM (Subscriber Identification Module) card, of the user's mobile device, e.g. mobile phone or PDA. The b-Contract contains all the details of the training progress, results of assessments, the responses of the customer and the criteria for evaluation.

The customer can connect to any assessment services provided by the service provider whenever the customer tries to put his/her mobile device in a close distance with the sensors of the equipment. The user's mobile device can also connect to the service portal or service provider's server for services. The services include training services, tests, performance evaluation etc. For example, a sensor 120 can collect performance records from an electronic piano 122, to which the sensor 120 is embedded or associated. When a consumer places his/her mobile phone 126 with a personal hardware token 128 close to the sensor 120, it will interact with the sensor 120 and obtain various information and details, including performance records stored in the electronic piano 122. The performance records will then be evaluated by the personal hardware token 128 and/or a server 124 of the service provider based on the contents of b-Contract, via the process of b-footprinting.

Assuming that evaluation of the performance records is carried out by the server 124, the result of the assessment, possibly including advice and suggestions, is transmitted by the server 124 to the SN Agent 128. Upon receipt of confirmation from the user, the feedback from the server 124 is transmitted to the sensor 120 for onward transmission to the electronic piano 122 for display.

Such a process completely automates the process of assessment or evaluation required during training and tests because the process forms a trusted environment for the personal hardware token to interact with the sensors on training or assessment equipment. Since the assessment is done by the personal hardware token and/or the servers of the qualified assessment party, the assessment can be completely automated. The process also allows protection of data privacy that is critical for assessment and evaluation because all sensitive performance data will be protected by the personal hardware token. If assessment needs to be analyzed by the service provider, the design of b-footprint and b-footprinting will ensure that only required data are sent over for analysis.

In addition, credentials of the customer through different assessments from different service providers can also be consolidated and stored in the personal hardware token. It is thus possible to generate electronic proofs of credentials over different assessments.

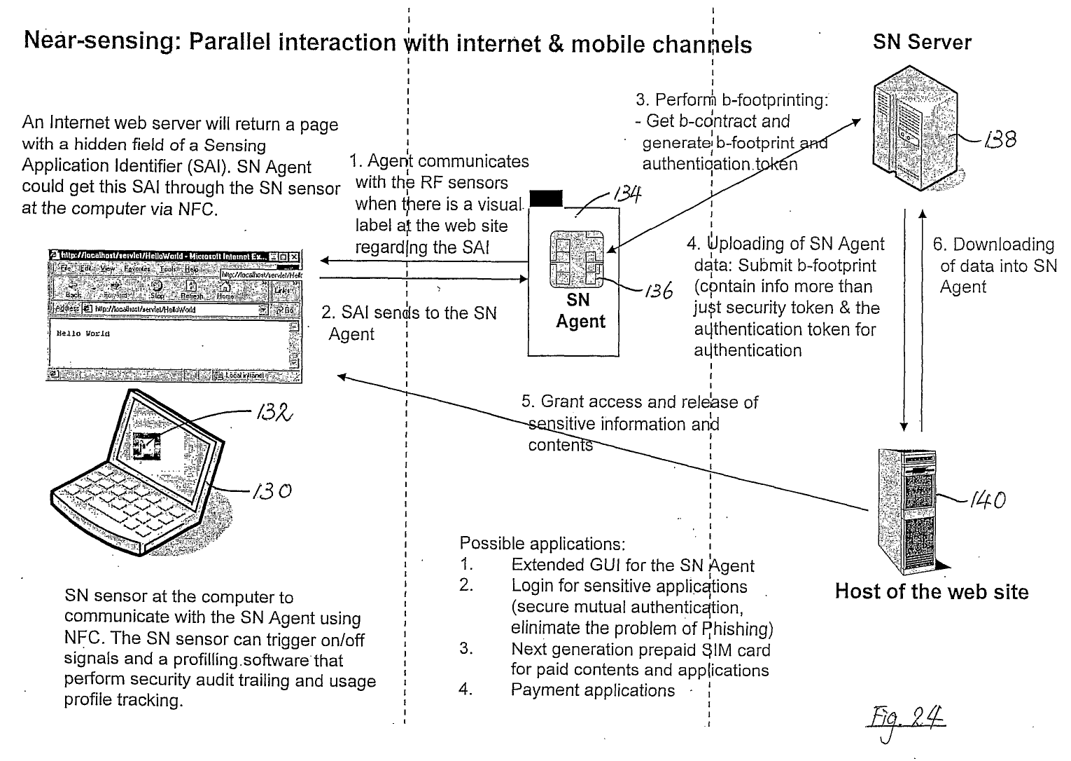

As shown in FIG. 24, a system and method according to the invention may be used in a near-sensing scenario, with parallel interaction with the Internet and mobile channels. For a computer (e.g. a personal computer or laptop computer) 130 embedded with an RF/IR sensor/tag (SN Sensor) 132, when it accesses a web site and the Internet web server returns a web page with a hidden field of a Sensing Application Identifier (SAI). When a user brings his/her mobile device 134 with a personal hardware token (SN Agent) 136 close to the computer 130, it can interact with the RF/IR sensor 132 when there is a visual label at the web site regarding the SAI. The SN Agent 136 can then obtain this SAI through the SN Sensor 132 at the computer 130 via NFC.

Upon receipt of the SAI, if the SN Agent has b-footprinting capability, it can perform b-footprinting. If not, it can generate b-footprint and authentication token for the SN Server 138 to perform b-footprinting. The SN Server 138 then uploads data of the SN Agent 136 to the host of the web site 140. Upon receipt of the b-footprint (which contains information more than just security token and the authentication token for authentication purpose), the host of the web site 140 will grant access and release of sensitive information and contents. The host 140 will also download data into the SN Server 138 for onward transmission to the SN Agent 136.

Such a system and method may be used in login for sensitive web applications (to ensure secure mutual authentication, and eliminate the problem of “Phishing”) and prepaid SIM card for the generation for paid contents and applications over the Internet.

A system and method according to the present invention may also be employed in a peer-to-peer sensing scenario, in which the personal hardware token of a user communicates with another personal hardware token of another user (Agent-Agent Interaction) through contactless technology such as NFC.

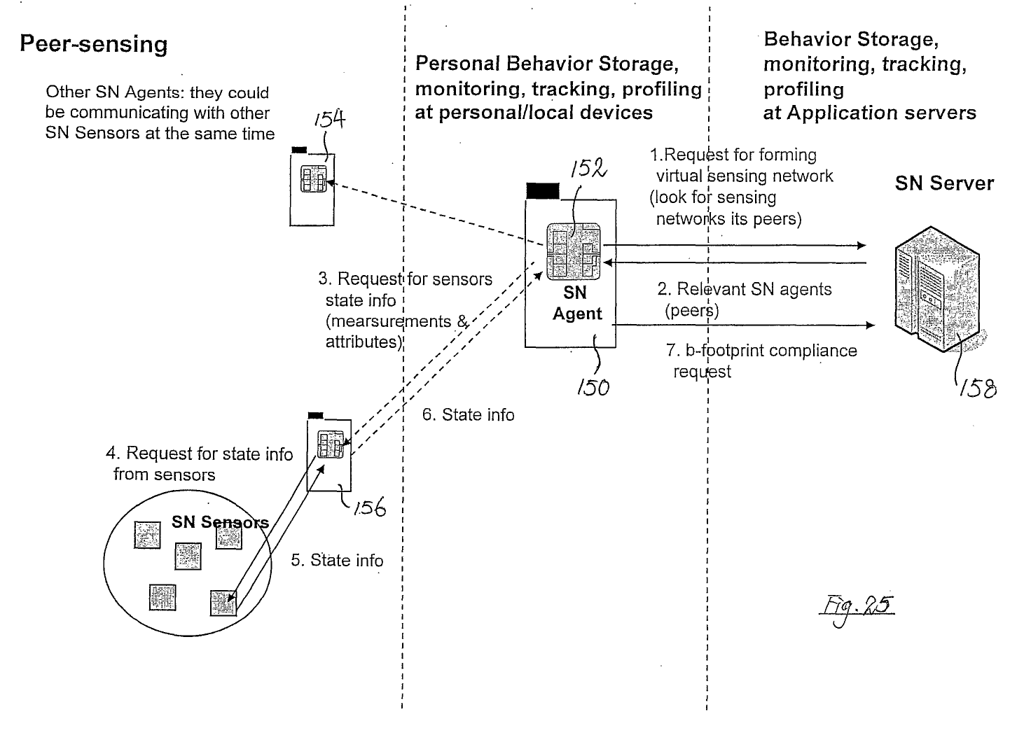

As shown in FIG. 25, interaction happens when a user tries to put his/her mobile device 150 with an SN Agent 152 to within a close distance with another mobile device 154 or 156, each with a respective SN Agent. The software on the mobile devices 152, 154, 156 can also connect to their own related IT servers, which are provided by the same or different service providers.

A group of customers can subscribe to a common service provided by a service provider, by which they will have peer relationship under the same service. Such peers share the same b-Contract for defining the rules of interaction among them. For example, it can contain the same rules of data sharing in their mobile devices. The peers can interact with one another whenever they try to put their mobile devices in a close distance (in other words, the peers need to be physically close to each other). The mobile devices can also connect to the service portal or service provider's server 158 for services. The services include profile-matching, data and file sharing, etc.

For example, the peers can search for the same or similar profiles (Behavioral States) stated in the personal hardware token. Strict control of data protection is required because only specific data are allowed to be shared. The personal hardware token will then suggest to the peers for follow-on actions based on the contents of b-Contract via the process of b-footprinting. The output of this process will be the update of the peer's profile onto the mobile devices and suggestions for coordination between specific peers.

Such facilitates a trusted environment for the peers who have subscribed to the same service interact with one another based on the details defined in the b-Contract and through the process of b-footprinting. The process can also test and verify whether the responses and/or actions taken by a peer comply with the pre-set rules defined in the b-Contract. The interactions include data sharing, file- and profile-sharing on their mobile devices. The process will protect data privacy because only specific data will be shared in a restricted way.

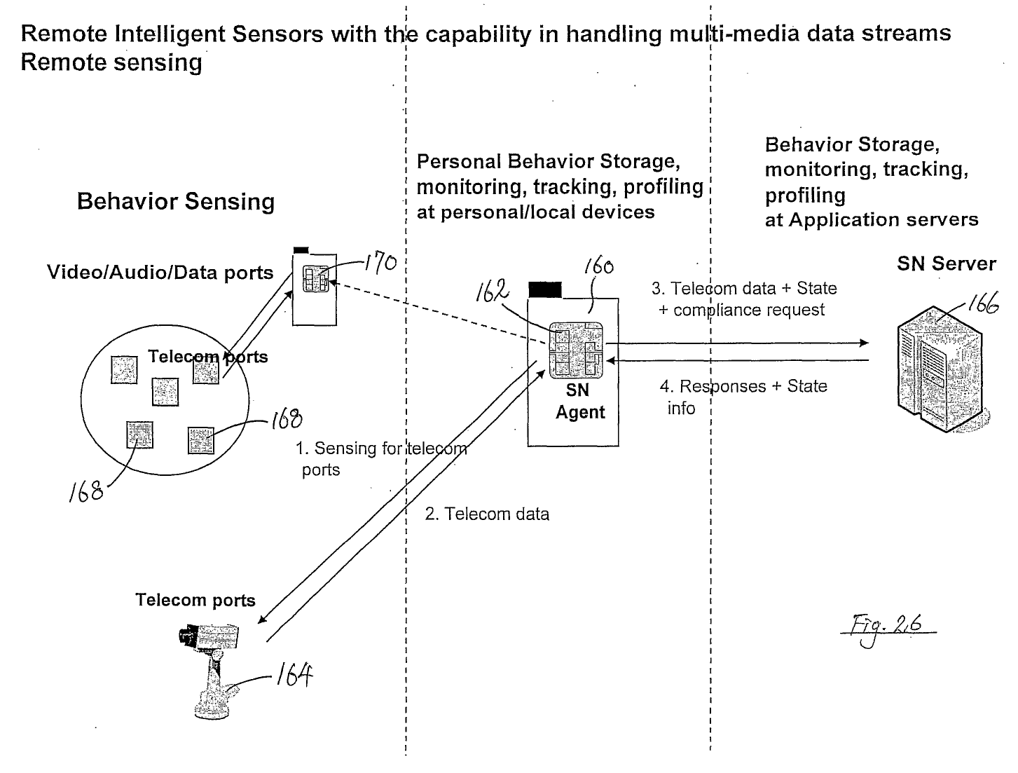

A further scenario in which a system and method according to the present invention may be carried out is remote sensing with remote intelligent sensors capable of handling multi-media data streams. As shown in FIG. 26, a user of a mobile device 160 with an SN Agent 162 may bring the mobile device 160 close to a telecom port 164 (that is the interface of a telecommunication device that handles input and output of multimedia data). Upon sensing of the telecom port 164, the SN Agent 162 establishes connection with the telecom port 164 and obtains audio/visual/multi-media data from the telecom port 164. The SN Agent 162 then transmits the data received from the telecom port 164, the State and compliance request to an SN Server 166, at which behavior storage, monitoring, tracking, profiling are carried out. Responses and State information from the SN Server 166 are then transmitted back to the SN Agent 162. Personal behavior storage, monitoring, tracking, profiling are carried out by the SN Agent 162.

The SN Agent 162 may also be connected with, and receive audio/visual/multi-media data streams from, telecom ports 168 via an intermediate SN Agent 170, which is in connection with the SN Agent 162 and with the telecom ports 168.

In a further application of a system and a method according to the present invention, sensors such as RFID are tagged on the container of medicine. They communicate with the user's personal hardware token via NFC. The personal hardware token in the mobile device can then connect to the providers of medical services.

Patients with chronic diseases such as diabetics require long-term medication. In this service, doctors (or medical personnel) could track or monitor how their patients take medication based on their prescription and advice. Doctors can also provide advice and other services to the patients whenever their patients place their mobile device close enough to the tagged sensor.

The patient subscribes to a service provided by his/her doctor or medical service provider. When the patient goes for consultation with the doctor, a medical b-Contract can be downloaded to the patient's mobile device. The b-Contract defines the details that include the rules of medication taking and all the related possible actions. The patient can connect to the services provided by the doctor whenever he/she put the mobile phone close enough to the sensor tagged on the container of medicine. Other input such as body temperate and heartbeat rate can also be sent to the service provider for getting real-time advice or output of the services.

By way of such an arrangement, patients can get connected to the services provided by doctors and medical personnel easily because the details and the status of the medicine will be sent seamlessly for analysis. Advice and tracking results could then be obtained in real-time. Patients can also verify the medication and its details such as dosage and frequency of taking instantly and directly. Doctors and medical personnel could adjust their advice and output of services based on the current situation of the patients.

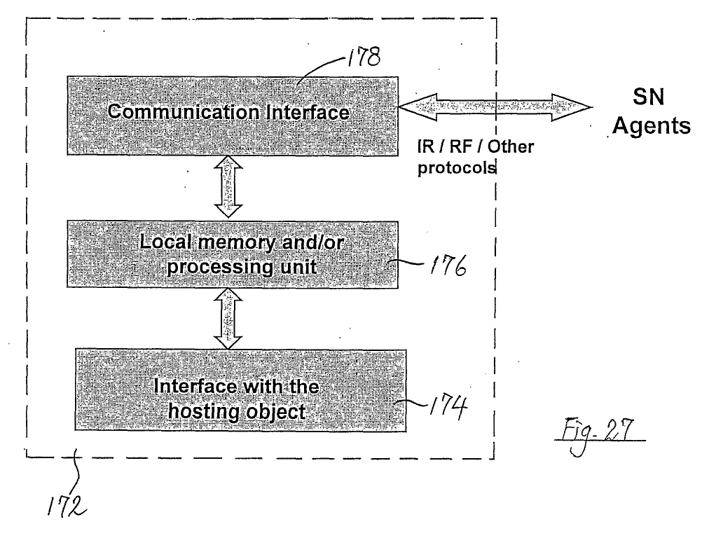

FIG. 27 shows a software infrastructure for an SN Sensor for mobile sensing services. It can be seen that an SN Sensor 172 has an interface 174 for interfacing with and obtaining measurements of certain attributes or conditions of the hosting object, be it a car, a bottle of perfume, an electronic piano, a video camera, or a computer. The interface 174 is in communication with a local memory and/or processing unit 176. As discussed above, passive SN Sensors will usually not have a processing unit, as such sensors will be active only upon activation and they normally support read-only functions. On the other hand, active SN Sensors support active communication (with read and write capability), and can actively communicate with readers and peers. Such sensors will have a processing unit, the processing power of which depending on the functions to be carried out by the sensors.

The local memory and/or processing unit 176 is also in communication with a communication interface 178 for establishing contactless communication with SN Agents, e.g. via IR, RF or other protocols. Such an arrangement allows data and information obtained by the Interface 174 from the environment (e.g. the hosting object) to be transmitted to SN Agents, and responses from the SN Agents to be received via the communication interface 178 into the local memory and/or processing unit 176, either for storage or execution of the requested sensor-side action.

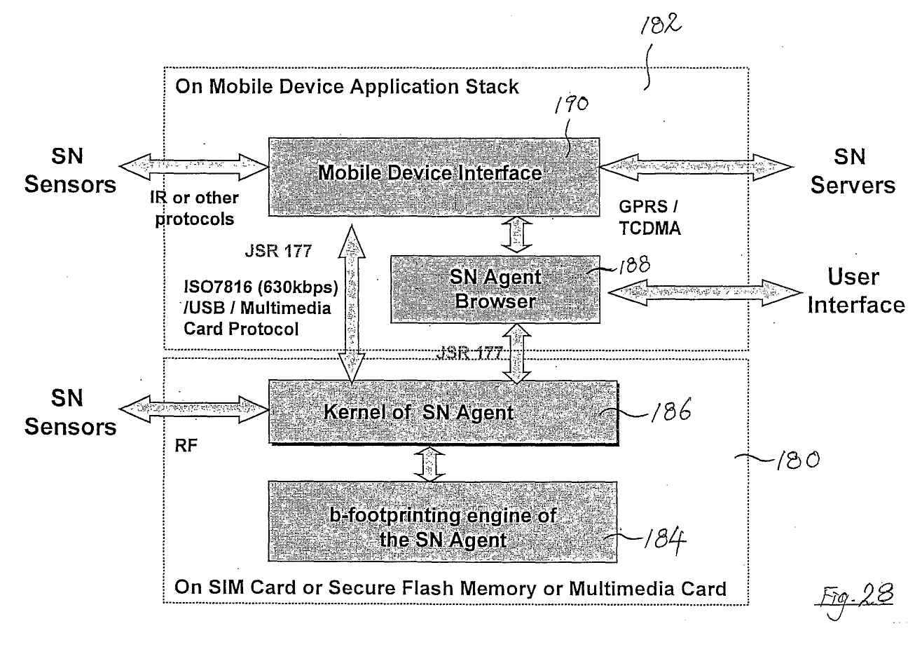

FIG. 28 shows a software infrastructure for an SN Agent for mobile sensing services. Such includes software on an SIM card/secure flash memory/multimedia card 180, and that on mobile device application stack 182. On the SIM card/secure flash memory/multimedia card 180 are b-footprinting engine 184 of the SN Agent, which is in communication with a kernel 186 of the SN Agent. The kernel 186 may communicate with an SN Sensor via RF transmission protocol.

The kernel 186 is also in communication with an SN Agent Browser 188, which may communicate with a user interface. Both the kernel 186 and the SN Agent Browser 188 are in communication with a mobile device interface 190, which may, on the one hand, communicate with SN servers via GPRS or TCDMA protocols and, on the other hand, communicate with the SN Sensor.

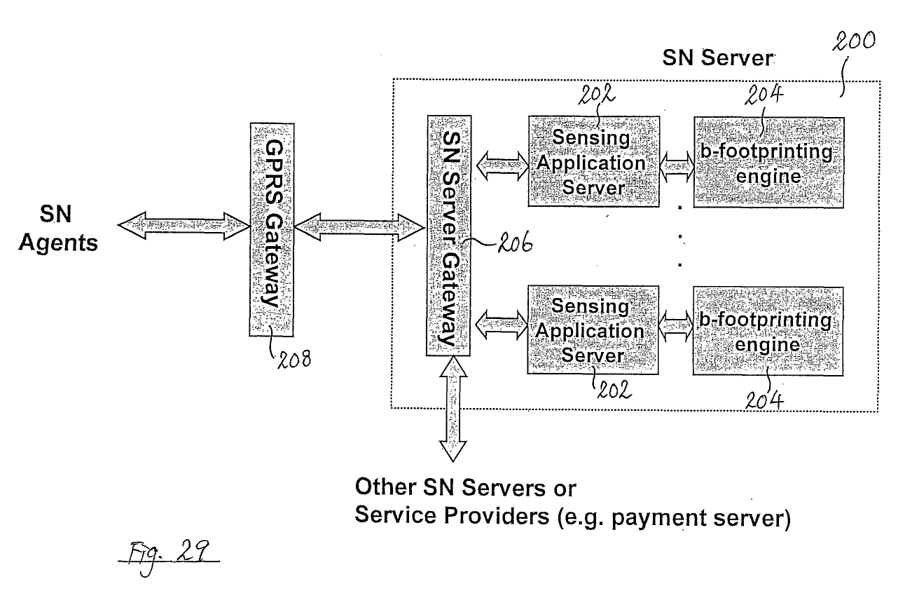

FIG. 29 shows a software infrastructure for an SN Server for mobile sensing services. An SN Server 200 includes a number of groups of Sensing Application Server 202 and b-footprinting engine 204. Each Sensing Application Server 202 is, on the one hand, in communication with its respective b-footprinting engine 204, and on the other hand, in communication with an SN Server Gateway 206. The SN Server Gateway 206 may communicate with the SN Agents of the system via a GPRS Gateway 208. The SN Server Gateway 206 may also be in communication with other SN Servers or service providers (e.g. payment server).

1. A communication method, including the steps of:
(a) associating at least one sensor with a first object;
(b) associating a second object with at least one secure token adapted to communicate contactlessly with said sensor;
(c) setting at least a first rule of possible or allowable way of interaction between said first and second objects;
(d) said sensor obtaining information relating to said first object;
(e) said secure token initiating and establishing contactless communication with said sensor and receiving from said sensor said information obtained by said sensor; and
(f) said secure token issuing an output on the basis of said at least first rule of possible or allowable way of interaction and said information received from said sensor.

2. A method according to claim 1 wherein said secure token communicates with said sensor via RF protocol, IR protocol and/or NFC.

3. A method according to claim 1 wherein said second object is a mobile communication device or a personal digital assistant.

4. A method according to claim 1 wherein said secure token is a Universal Subscriber Identification Module (USIM)/Subscriber Identification Module (SIM) card.

5. A method according to claim 1 wherein said secure token is also a sensor.

6. A method according to claim 1 further including a step (g) of storing the history of interactions between said sensor and said secure token.

7. A method according to claim 6 wherein said history of interactions between said sensor and said secure token is stored in said secure token.

8. A method according to claim 6 wherein said history of interactions between said sensor and said secure token is stored in said sensor.

9. A method according to claim 1 further including a step (h) of storing the outputs issued by said secure token in said step (f).

10. A method according to claim 1 wherein said output issued in said step (f) includes a suggested course of action, results of evaluation, or a suggested second rule of possible or allowable way of interaction between said first and second objects.

11. A method according to claim 10 further including a step (i) of a user continuing said suggested course of action.

12. A method according to claim 10 further including a step (j) of a user refusing said suggested course of action.

13. A method according to claim 10 further including a step (k) of a user confirming said suggested second rule of possible or allowable way of interaction between said first and second objects.

14. A method according to claim 10 further including as step (l) of a user refusing said suggested second rule of possible or allowable way of interaction between said first and second objects.

15. A method according to claim 1 further including a step (m) of forwarding the history of interactions between said sensor and said secure token to a server remote of said secure token.

16. A method according to claim 1 wherein, in said step (e), said secure token establishes contactless communication with said sensor and receiving from said sensor said information obtained by said sensor via at least a second secure token.

17. A method according to claim 1 wherein, in said step (e), said secure token establishes contactless communication with a plurality of sensors each associated with a respective object, and receives from said sensors said information obtained by said sensors.

18. A method according to claim 1 wherein, in said step (c), a set of possible or allowable ways of interaction between said first and second object are set.

19. A method according to claim 1 wherein in said step (f), said secure token issues said output to said sensor of said second object.

20. A method according to claim 19 wherein said output comprises instructions to said sensor to execute an action.

21. A method according to claim 19 wherein said output comprises information to be outputted by said second object.

22. A method according to claim 19 wherein in said step (f), said secure token issues said output to another secure token to execute an action.

23. A method according to claim 1 wherein said at least one rule of possible or allowable way of interaction is unique to said secure token.

24. A method according to claim 1 further including the following steps:
(n) identifying critical checkpoints of measurements/attributes;
(o) setting a time window of state records;
(p) generating ranges of input stamps on the basis of said time window;
(q) generating at least a summary of measurements within said time window on the basis of said critical checkpoints of measurements/attributes;
(r) generating at least a summary of actions/responses within said time window on the basis of said critical checkpoints of measurements/attributes;
(s) generating at least a summary of analyzed results within said time window on the basis of said critical checkpoints of measurements/attributes;
(t) generating a historical stage profile based on the outputs of steps (o) to (s); and
(u) removing the state records within said time window from the memory.

25. A communication system comprising at least one sensor associated with, and adapted to obtain information relating to, a first object, and at least one secure token associated with a second object; wherein said secure token is adapted to initiate and establish contactless communication with said sensor and to receive from said sensor said information obtained by said sensor; and wherein said secure token is adapted to issue an output on the basis of at least a first pre-set rule of possible or allowable way of interaction between said first and second objects and said information received from said sensor.

26. A system according to claim 25 wherein said secure token is adapted to communicate with said sensor via RF protocol, IR protocol and/or NFC.

27. A system according to claim 25 wherein said second object is a mobile communication device or a personal digital assistant.

28. A system according to claim 25 wherein said secure token is a Universal Subscriber Identification Module (USIM)/Subscriber Identification Module (SIM) card.

29. A system according to claim 25 wherein said secure token is also a sensor.

30. A system according to claim 25 further including means storing the history of interactions between said sensor and said secure token.

31. A system according to claim 30 wherein said history of interactions between said sensor and said secure token is stored in said secure token.

32. A system according to claim 30 wherein said history of interactions between said sensor and said secure token is stored in said sensor.

33. A system according to claim 25 further including means for storing the outputs issued by said secure token.

34. A system according to claim 25 wherein said output issued by said personal hardware token includes a suggested course of action, results of evaluation, or a suggested second rule of possible or allowable way of interaction between said first and second objects.

35. A system according to claim 34 further including means for allowing a user to confirm said suggested course of action.

36. A system according to claim 34 further including means for allowing a user to refuse said suggested course of action.

37. A system according to claim 34 further including means for allowing a user to confirm said suggested second rule of possible or allowable way of interaction between said first and second objects.

38. A system according to claim 34 further including means for allowing a user to refuse said suggested second rule of possible or allowable way of interaction between said first and second objects.

39. A system according to claim 25 further including a remote server communicable with said first object.

40. A system according to claim 25 further including means for forwarding the history of interactions between said sensor and said secure token to said remote server.

41. A system according to claim 25 further including at least a second secure token via which said secure token is adapted to establish contactless communication with said sensor and receiving from said sensor said information obtained by said sensor.

42. A system according to claim 25 further including a plurality of sensors each being associated with a respective object, and adapted to obtain information therefrom.

43. A system according to claim 25 wherein said secure token is adapted to issue outputs on the basis of a set of pre-set rules of possible or allowable ways of interaction between said first and second objects and said information received from said sensor.

44. A system according to claim 25 wherein said secure token is adapted to issue said output to said sensor of said second object.

45. A system according to claim 44 wherein said sensor is adapted to execute an action in accordance with instructions outputted by said secure token.

46. A system according to claim 44 wherein said sensor is adapted to output information received from said second object.
